(19) United States
(12) Patent Application Publication
(10) Pub. No.: US 2024/0154159 A1
(43) Pub. Date: May 9, 2024

(54) Electrolyte, Lithium Battery Including the Same, and Method of Preparing the Electrolyte

(71) Applicant: Samsung Electronics Co., Ltd., Suwon-si, Gyeonggi-do, (KR)

(72) Inventors: Sangbok MA, Suwon-si, Gyeonggi-do, (KR); Giyun KWON, Suwon-si, Gyeonggi-do, (KR); Hyeokjo GWON, Suwon-si, Gyeonggi-do, (KR); Youngjoon BAE, Suwon-si, Gyeonggi-do, (KR); Gabin YOON, Suwon-si, Gyeonggi-do, (KR)

(21) Appl. No.: 18/363,310

(22) Filed: Aug. 1, 2023

(30) Foreign Application Priority Data
Aug. 23, 2022 (KR) 10-2022-0105769

(51) Int. Cl. H01M 10/0562

(52) U.S. Cl. CPC H01M 10/0562; H01M 2300/0071

(57) ABSTRACT

An electrolyte including a compound, the compound represented by Formula 1:

Li_{w}AlₓS_{y}O₄ Formula 1
wherein, in Formula 1, 2.9≤w≤4.7, 0.3≤x≤0.9, and 0.1≤y≤0.7, and
wherein the compound is amorphous.

### CROSS-REFERENCE TO RELATED APPLICATION

This application is based on and claims priority to Korean Patent Application No. 10-2022-0105769, filed on Aug. 23, 2022, in the Korean Intellectual Property Office, and all the benefits accruing therefrom under 35 U.S.C. § 119, the content of which is incorporated by reference herein in its entirety.

### BACKGROUND

### 1. Field

The disclosure relates to an electrolyte, a lithium battery including the same, and a method of preparing the electrolyte.

### 2. Description of the Related Art

A lithium battery may provide improved specific energy and improved energy density. Alternatively, a lithium battery may provide improved power density.

For improved stability, a lithium battery may include a solid electrolyte. A solid electrolyte has poor stability at a high voltage, or has very low ionic conductivity compared to a liquid electrolyte. Thus there remains a need for an improved solid electrolyte.

### SUMMARY

Provided is a novel electrolyte.

Provided is a lithium battery including the electrolyte.

Provided is a method of preparing the electrolyte.

Provided is a method of manufacturing the lithium battery including the electrolyte.

Additional aspects will be set forth in part in the description which follows and, in part, will be apparent from the description, or may be learned by practice of the presented embodiments of the disclosure.

According to an aspect of the disclosure, provided is an electrolyte including a compound, the compound represented by Formula 1:

Li_{w}AlₓS_{y}O₄ Formula 1

wherein, in Formula 1, 2.9≤w≤4.7, 0.3≤x≤0.9, and 0.1≤y≤0.7, and wherein the compound is amorphous.

According to another aspect of the disclosure, a lithium battery may include a cathode, an anode, and an electrolyte disposed between the cathode and the anode, the cathode, the anode, the electrolyte, or a combination thereof, may include the electrolyte disclosed herein.

According to another aspect of the disclosure, disclosed is a method of preparing an electrolyte including a compound, the method includes providing a first starting material including a crystalline Li₅AlO₄ and a lithium compound including a crystalline Li₂SO₄; and mechanochemically contacting the first starting material and the lithium compound to prepare an amorphous compound represented by Formula 1

Li_{w}AlₓS_{y}O₄ Formula 1

wherein, in Formula 1, 2.9≤w≤4.7, 0.3≤x≤0.9, and 0.1≤y≤0.7, to prepare the electrolyte including the compound.

According to another aspect of the disclosure, a method of manufacturing a lithium battery may include providing a cathode, providing an anode, and disposing an electrolyte between the cathode and the anode to manufacture the lithium battery, wherein the cathode, the anode, the electrolyte, or a combination thereof, may include the electrolyte including the compound represented by Formula 1.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a graph of intensity (arbitrary units, a.u.) vs. diffraction angle (degrees two-theta (2θ)) showing the results of X-ray diffraction analysis using CuKα radiation of electrolytes prepared in Comparative Examples 1 and 2 and Example 3;

FIG. 2 is a graph of proportion (percent, %) vs. lithium to oxygen distance (angstroms, A) showing the results of density functional theory (DFT) analysis of lithium to oxygen atom distance for each of amorphous Li₅AlO₄ and amorphous Li_{3.8}Al_{0.6}S_{0.4}O₄;

FIG. 3 is a graph of proportion (percent, %) vs. lithium to lithium distance (A) showing results of DFT analysis of a distance between lithium atoms for each of the amorphous Li₅AlO₄ and the amorphous Li_{3.8}Al_{0.6}S_{0.4}O₄;

FIG. 4 is a graph of Li-ion conductivity (10⁻⁷ Siemens per centimeter, S/cm) vs. proportion of Li₂SO₄ showing the results of ionic conductivity measurement for the electrolytes of Examples 1 to 4, a crystalline Li₅AlO₄ electrolyte of Comparative Example 1, a crystalline Li₂SO₄ electrolyte of Comparative Example 3, an amorphous Li_{2.3}Al_{0.1}S_{0.9}O₄ electrolyte of Comparative Example 4, and an amorphous Li_{2.6}Al_{0.2}S_{0.8}O₄ electrolyte of Comparative Example 5;

FIG. 5 is a schematic diagram of a crystal structure of a crystalline Li₅AlO₄;

FIG. 6 is schematic diagram of an embodiment of a structure of a lithium ion battery;

FIG. 7 is schematic diagram of an embodiment of a structure of a lithium ion battery;

FIG. 8 is schematic diagram of an embodiment of a structure of a lithium ion battery;

FIG. 9 is schematic diagram of an embodiment of a structure of an all-solid-state battery;

FIG. 10 is schematic diagram of an embodiment of a structure of an all-solid-state battery;

FIG. 11 is schematic diagram of an embodiment of a structure of an all-solid-state battery;

FIG. 12 is schematic diagram of an embodiment of a multilayer ceramic battery;

FIG. 13 is schematic diagram of an embodiment of a multilayer ceramic battery; and

FIG. 14 is schematic diagram of an embodiment of a multilayer ceramic battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figure, to explain various aspects. The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

The present inventive concept described hereinbelow may have various modifications and various embodiments, example embodiments will be illustrated in the drawings and more fully described in the detailed description. The present inventive concept may, however, should not be construed as limited to the example embodiments set forth herein, and rather, should be understood as covering all modifications, equivalents, or alternatives falling within the scope of the present inventive concept. Rather, these embodiments are provided so that this disclosure will be thorough and complete, and will fully convey the scope of the invention to those skilled in the art. Like reference numerals refer to like elements throughout.

The terms used herein is for the purpose of describing particular embodiments only, and is not intended to be limiting the present inventive concept. An expression used in the singular encompasses the expression of the plural, unless it has a clearly different meaning in the context. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. As used herein, “/” may be interpreted as “and”, or as “or” depending on the context.

In the drawings, thicknesses may be magnified or exaggerated to clearly illustrate various layers and regions. Like reference numbers may refer to like elements throughout the drawings and the following description. It will be understood that when one element, layer, film, section, sheet, etc. is referred to as being “on” another element, it can be directly on the other element or intervening elements may be present therebetween. Although the terms “first,” “second,” etc. may be used herein to describe various elements, these elements should not be limited by these terms. These terms are only used to distinguish one element from another element.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value. Endpoints of ranges may each be independently selected.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term “metal” disclosed herein includes both a metal and a metalloid, such as silicon and germanium, in an elemental state or an ionic state.

The term “alloy” disclosed herein refers to a mixture of two or more metals.

The term “positive active material” disclosed herein refers to a cathode material capable of undergoing lithiation and delithiation.

The term “negative active material” disclosed herein refers to an anode material capable of undergoing lithiation and delithiation.

The terms “lithiation” and “lithiate” disclosed herein refer to a process of adding lithium to a cathode active material or an anode active material.

The terms “delithiation” and “delithiate” disclosed herein refer to a process of removing lithium from a cathode active material or an anode active material.

The terms “charging” and “charge” disclosed herein refer to a process of providing electrochemical energy to a battery.

The terms “discharging” and “discharge” disclosed herein refer to a process of eliminating electrochemical energy from a battery.

The terms “cathode” and “positive electrode” disclosed herein refer to an electrode in which electrochemical reduction and lithiation occur during a discharge process.

The terms “anode” and “negative electrode” disclosed herein refer to an electrode in which electrochemical oxidation and delithiation occur during a charge process.

As used herein, the term “diameter” of a particle refers to an average diameter of the particle if the particle is spherical, and for a non-spherical particle, refers to an average major axis length of the particle. The particle diameter of the particles may be measured using a particle size analyzer (PSA). A “diameter” of a particle is, for example, an average diameter. An average particle diameter refers to a median particle diameter (D50), unless explicitly stated otherwise. The medium particle diameter D50 refers to, in a cumulative distribution curve of particle sizes where particles accumulate in the order of particle size from the smallest to the largest, the size of particles corresponding to a cumulative value of 50% calculated from particles having the smallest particle size. The cumulative value may be, for example, a cumulative volume. The median particle diameter D50 may be, for example, measured by laser diffraction.

Hereinafter, an electrolyte according to an embodiment, a lithium battery including the same, and a method of preparing the electrolyte will be described in more detail.

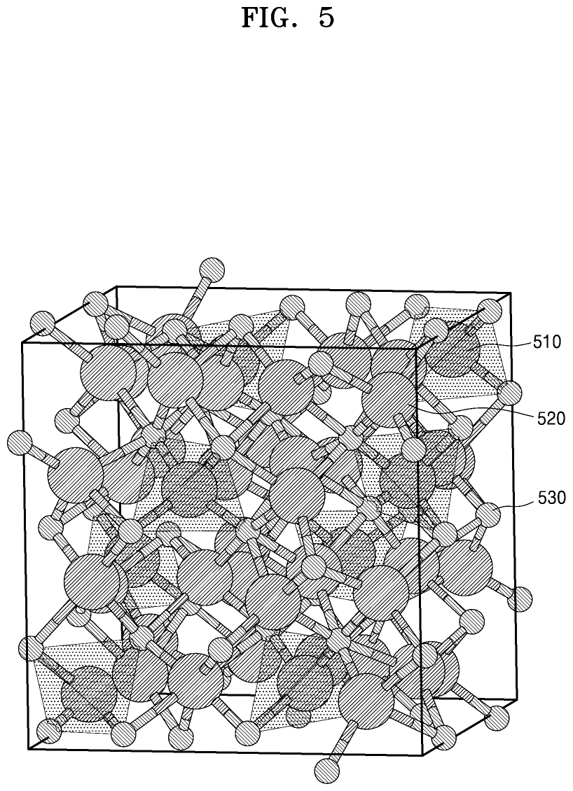

Referring to FIG. 5, Li₅AlO₄ is a crystalline lithium metal oxide having a spinel-like crystal structure. As shown in FIG. 5, the crystalline lithium metal oxide has an aluminum atom 510, an oxygen atom 520, a lithium atom 530. Li₅AlO₄ may be electrochemically stable at a high voltage greater than or equal to 5 volts (V, vs. Li), and may be chemically stable in a high-temperature molten salt state. A crystalline Li₅AlO₄ may have very low ionic conductivity of 1×10⁻⁹ S/cm at 25° C. Accordingly, there is a need for an electrolyte having improved ionic conductivity while maintaining excellent stability at the high voltage.

### Electrolyte

An electrolyte comprises a compound according to an embodiment, the compound is represented by Formula 1:

Li_{w}AlₓS_{y}O₄ Formula 1

wherein, in Formula 1, 2.9≤w≤4.7, 0.3≤x≤0.9, and 0.1≤y≤0.7, and
wherein the compound is amorphous.

For example, in Formula 1, w, x, and y, may each be 2.9≤w≤4.4, 0.3≤x≤0.8, and 0.2≤y≤0.7. For example, in Formula 1, w, x, and y, may each be 2.9≤w≤4.1, 0.3≤x≤0.7, and 0.3≤y≤0.7. For example, in Formula 1, w, x, and y, may each be 2.9≤w≤3.8, 0.3≤x≤0.6, and 0.4≤y≤0.7. For example, in Formula 1, w, x, and y, may each be 2.9≤w≤3.5, 0.3≤x≤0.5, and 0.5≤y≤0.7. The electrolyte comprising the compound, the compound represented by Formula 1 may be a solid electrolyte. The electrolyte may include, for example, the compound represented by Formula 1 or an ionic conductor. The amorphous compound herein refers to a compound not having crystallinity or having very low crystallinity, and is distinguished from a crystalline compound. Amorphous, as used herein, means that the compound has less than 10 weight percent crystalline content, e.g., 0.01 to 5 wt %, or 0.1 to 1 wt %, based on a total weight of the metal oxide, when determined by X-ray powder diffraction analysis.

Since the compound represented by Formula 1 is amorphous, lithium transfer may be easier in the electrolyte than in a crystalline electrolyte. The electrolyte comprising the compound, the compound represented by Formula 1 may be electrochemically stable at a high voltage due to inclusion of an SO₄²⁻ unit. The electrolyte comprising the compound, the compound represented by Formula 1 may provide a mixed anion effect by simultaneously including a AlO₄²⁻ unit and the SO₄²⁻ unit. Consequently, the electrolyte comprising the compound, the compound represented by Chemical Formula 1 may be, for example, electrochemically stable at a voltage in a wide range of about 0 V to about 5.0 V compared to lithium metal, and may provide an improved ionic conductivity.

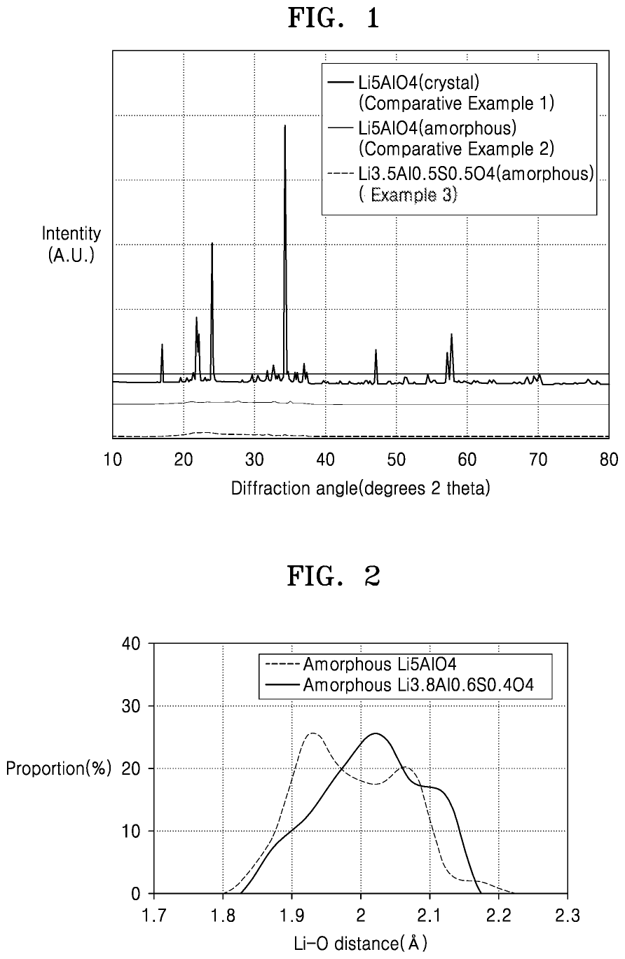

Referring to FIG. 1, the electrolyte comprising the compound, the compound represented by Formula 1 has a first peak at a diffraction angle of 21.5±1.0° 2θ, a second peak at a diffraction angle of 24.0±1.0° 2θ, a third peak at a diffraction angle of 35.0±1.0° 2θ, when analyzed by an X-ray diffraction using CuKα radiation. A ratio (Ib/Ia) of an intensity of the second peak (Ib) to an intensity of the first peak (Ia) may be less than or equal to about 1.5, less than or equal to about 1.0, less than or equal to about 0.5, or less than or equal to about 0.1. In an aspect, the ratio of the intensity of the second peak (Ib) to the intensity of the first peak (Ia) may be about 0.001 to about 1.5, about 0.001 to about 1.0, or about 0.001 to about 0.5. When the electrolyte has the peak intensity ratio Ib/Ia within the ranges above, improved ionic conductivity may be provided.

Referring to FIG. 1, a ratio (Ic/Ia) of an intensity of a third peak (Ic) to the intensity of the first peak (Ia) may be less than or equal to about 1.5, less than or equal to about 1.0, less than or equal to about 0.5, or less than or equal to about 0.1. In an aspect, the ratio of the intensity of the third peak (Ic) to the intensity of the first peak (Ia) may be about 0.001 to about 1.5, about 0.001 to about 1.0, or about 0.001 to about 0.5. When the electrolyte has the peak intensity ratio Ic/la within the ranges above, improved ionic conductivity may be provided.

Referring to FIG. 1, a ratio (Ia/Iaa) of the intensity of the first peak of the electrolyte (Ia) at the diffraction angle of 21.5±1.0° 2θ in the XRD spectrum of the electrolyte represented by Formula 1 to an intensity of a first peak of a crystalline Li₅AlO₄ (Iaa) at a diffraction angle of 21.5±1.0° 2θ in an XRD spectrum of the crystalline Li₅AlO₄ measured under the same condition as the electrolyte represented by Formula 1 may be less than or equal to about 0.1, less than or equal to about 0.05, or less than or equal to about 0.01. In an aspect, the ratio of the intensity of the first peak of the electrolyte (Ia) to the intensity of the first peak of the crystalline Li₅AlO₄ (Iaa) may be about 0.001 to about 0.1, about 0.001 to about 0.05, or about 0.001 to about 0.01. When the electrolyte has the peak intensity ratio Ia/Iaa within the ranges above, improved ionic conductivity may be provided. Referring to FIG. 1, a ratio (Ib/Ibb) of the intensity of the second peak of the electrolyte (Ib) at the diffraction angle 28=24.0±1.0° 2θ in the XRD spectrum of the electrolyte represented by Formula 1 to an intensity of a second peak of the crystalline Li₅AlO₄ (Ibb) at a diffraction angle 28=21.5±1.0° 2θ in the XRD spectrum of the crystalline Li₅AlO₄ measured under the same condition as the electrolyte represented by Formula 1 may be less than or equal to about 0.1, less than or equal to about 0.05, or less than or equal to about 0.01. In an aspect, the ratio of the intensity of the second peak of the electrolyte (Ib) to the intensity of the second peak of the crystalline Li₅AlO₄ (Ibb) may be about 0.001 to about 0.1, about 0.001 to about 0.05, or about 0.001 to about 0.01. When the electrolyte has the peak intensity ratio Ib/Ibb within the ranges above, improved ionic conductivity may be provided.

Referring to FIG. 1, a ratio (Ic/Icc) of the intensity of the third peak of the electrolyte (Ic) at the diffraction angle 28=35.0±1.0° 2θ in the XRD spectrum of the electrolyte represented by Formula 1 to an intensity of a third peak of the crystalline Li₅AlO₄ (Icc) at a diffraction angle 28=35.0±1.0° 2θ in the XRD spectrum of the crystalline Li₅AlO₄ measured under the same condition as the electrolyte represented by Formula 1 may be less than or equal to about 0.1, less than or equal to about 0.05, or less than or equal to about 0.01. In an aspect, the ratio of the intensity of the third peak of the electrolyte (Ic) to the intensity of the third peak of the crystalline Li₅AlO₄ (Icc) may be about 0.001 to about 0.1, about 0.001 to about 0.05, or about 0.001 to about 0.01. When the electrolyte represented by Formula 1 has the peak intensity ratio Ic/Icc within the ranges above, improved ionic conductivity may be provided.

Referring to FIG. 2, a first distance between a lithium atom and an oxygen atom in the compound represented by Formula 1 may be greater than a second distance between a lithium atom and an oxygen atom in an amorphous Li₅AlO₄. The first distance refers to a distance at the highest frequency between the lithium atom and the oxygen atom in a distance distribution curve of the lithium atom and the oxygen atom in the compound represented by Formula 1, and the second distance refers to a distance at the highest frequency between the lithium atom and the oxygen atom in a distance distribution curve of the lithium atom and the oxygen atom in the amorphous Li₅AlO₄. For example, the first distance may be greater than about 2 angstroms (Å). For example, the second distance may be less than about 2 Å. In an aspect, the first distance may be greater than about 2.0 Å and the second distance may be less than about 2.0 Å, the first distance may be greater than about 1.98 Å and the second distance may be less than about 1.98 Å, or the first distance may be greater than about 1.95 Å and the second distance may be less than about 1.95 Å. In an aspect, the first distance may be about 2.0 Å to 2.1 Å, 1.98 Å to about 2.13 Å, or 1.95 Å to 2.15 Å, the second distance may be about 1.9 Å to about 2.0 Å, 1.85 Å to 1.98 Å, or 1.80 Å to 1.95 Å. For example, when the first distance is greater than the second distance, lithium mobility in the electrolyte comprising the compound, the compound represented by Formula 1 may increase, and thus improved ionic conductivity may be provided.

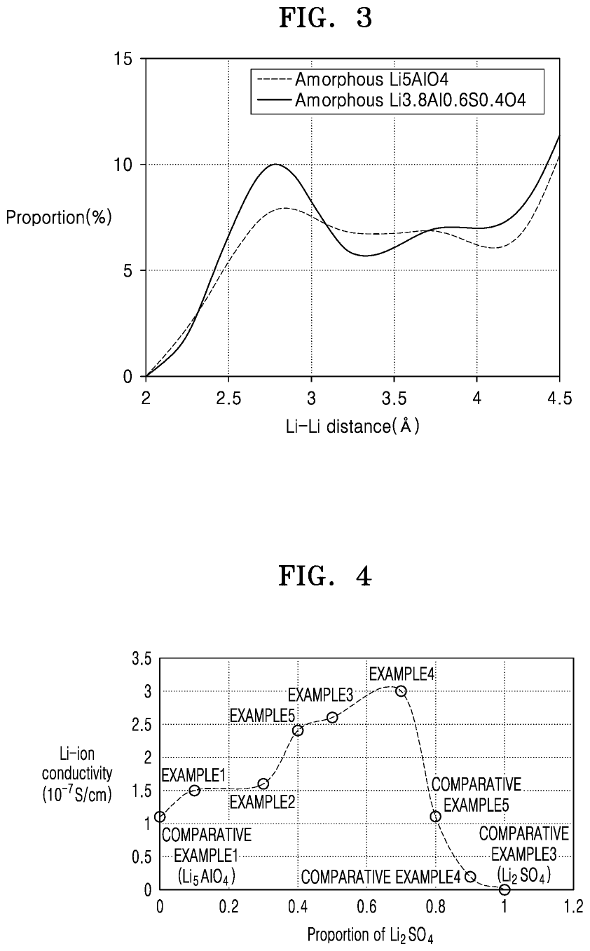

Referring to FIG. 3, a proportion of a third distance between lithium atoms in the compound represented by Formula 1 may be greater than a proportion of a fourth distance between lithium atoms in the amorphous Li₅AlO₄. The proportion of lithium atoms having the third distance refers to a proportion in which the distance between the lithium atoms in a distance distribution curve of the lithium atoms in the compound represented by Formula 1 is within a range of about 2.5 Å to about 3.5 Å, and the proportion of lithium atoms having the fourth distance refers to a proportion in which the distance between the lithium atoms in a distance distribution curve of the lithium atoms in the amorphous Li₅AlO₄ is within a range of about 2.5 Å to about 3.5 Å. For example, when the proportion of lithium atoms having the third distance is greater than the proportion of lithium atoms having the fourth distance, a lithium diffusion site may increase, and thus improved ionic conductivity may be provided.

The electrolyte comprising the compound, the compound represented by Formula 1 may include, for example, an ionic conductor, and the ionic conductor may include an AlO₄⁵⁻ unit and an SO₄²⁻ unit. A proportion of a content the AlO₄⁵⁻ unit to a total content of the AlO₄⁵⁻ unit and the SO₄²⁻ unit may be, for example, about 30 percent (%) to about 90%, about 30% to about 80%, about 30% to about 70%, about 30% to about 60%, or about 30% to about 50%. A proportion of a content of the SO₄²⁻ unit to the total content of the AlO₄⁵⁻ unit and the SO₄²⁻ unit may be, for example, about 10% to about 70%, about 20% to about 70%, about 30% to about 70%, about 40% to about 70%, or about 50% to about 70%. The proportion of the content of the AlO₄⁵⁻ unit to the total content of the AlO₄⁵⁻ unit and the SO₄²⁻ unit may be about 30% to about 90%, and the proportion of the content of the SO₄²⁻ unit to the total content of the AlO₄⁵⁻ unit and the SO₄²⁻ unit may be about 10% to about 70%. The “%” used to represent the proportion of the AlO₄⁵⁻ unit and the SO₄²⁻ unit refers to mol %. Contents of the AlO₄⁵⁻ unit and the SO₄²⁻ unit may be, for example, measured through induced coupled plasma (ICP) analysis.

The electrolyte comprising the compound, the compound represented by Formula 1 may include, for example, an ionic conductor, and lithium may be randomly disposed in the ionic conductor. By randomly disposing lithium in the ionic conductor, the ionic conductivity of the electrolyte may be further improved. Meanwhile, referring to FIG. 5, when lithium is regularly disposed in the crystalline Li₅AlO₄, ionic conductivity thereof may be limited.

The ionic conductivity of the electrolyte at about 25° C. may be greater than or equal to about 1×10⁻⁷ Siemens per centimeter (S/cm), greater than or equal to about 2×10⁻⁷ S/cm, or greater than or equal to about 3×10⁻⁷ S/cm. The ionic conductivity of the electrolyte represented by Formula 1 at about 25° C. may be about 1×10⁻⁷ S/cm to about 1×10⁻² S/cm, about 1×10⁻⁷ S/cm to about 1×10⁻³ S/cm, about 2×10⁻⁷ S/cm to about 1×10⁻³ S/cm, or about 3×10⁻⁷ S/cm to about 1×10⁻³ S/cm. When the electrolyte has such increased ionic conductivity within the ranges above, the electrolyte may be used for a lithium battery.

The lithium diffusion barrier of the electrolyte may be less than or equal to about 600 millielectronvolts (meV), less than or equal to about 580 meV, less than or equal to about 560 meV, less than or equal to about 540 meV, less than or equal to about 520 meV, or less than or equal to about 500 meV. In an aspect, the lithium diffusion barrier of the electrolyte represented by Formula 1 may be about 1 meV to about 600 meV, about 1 meV to about 580 meV, about 1 meV to about 560 meV, about 1 meV to about 540 meV, about 1 meV to about 520 meV, or about 1 meV to about 500 meV. When the electrolyte represented by Formula 1 has such low lithium diffusion barrier within the ranges above, lithium diffusion in the electrolyte may be facilitated, and thus the ionic conductivity of the electrolyte may be improved.

### Lithium Battery

A lithium battery according to an embodiment comprises: a cathode; an anode; and an electrolyte disposed between the cathode and the anode, wherein the cathode, the anode, the electrolyte, or a combination thereof, comprises the electrolyte comprising the compound, the compound represented by Formula 1. A method of manufacturing a lithium battery may comprise providing a cathode, providing an anode, and disposing an electrolyte between the cathode and the anode to manufacture the lithium battery, wherein the cathode, the anode, the electrolyte, or a combination thereof, may comprise the electrolyte according to claim 1.

When the lithium battery includes the electrolyte comprising the compound, the compound represented by Formula 1, an internal resistance of the lithium battery may be reduced, and cycle characteristics of the lithium battery may be improved. The lithium battery is not particularly limited, and for example, may be a lithium ion battery, an all-solid-state battery, a multilayer ceramic (MLC) battery, or a lithium-air battery. These batteries will be described in more detail below.

### (Lithium Ion Battery)

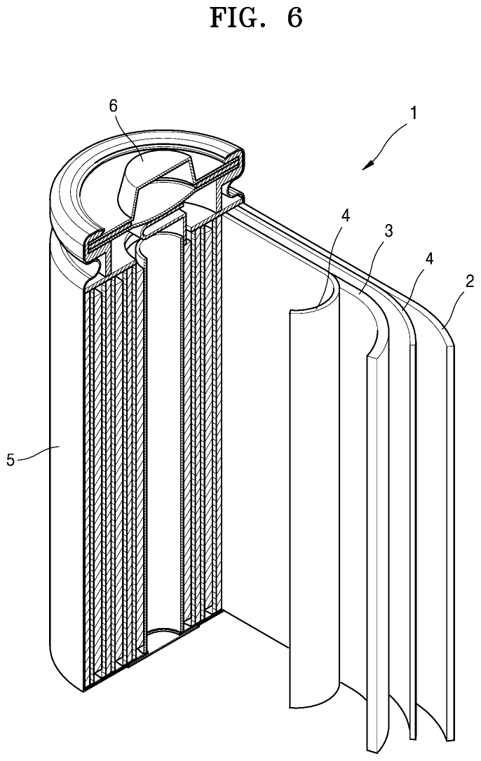

FIGS. 6 to 8 are each a schematic view of a lithium ion battery according to an embodiment.

A lithium ion battery may be, for example, a lithium battery including a liquid electrolyte. The lithium ion battery may include the electrolyte comprising the compound, the compound represented by Formula 1.

The lithium ion battery may include: for example, a cathode including a cathode active material; an anode including an anode active material; and a liquid electrolyte disposed between the cathode and the anode, wherein the cathode, the anode, or a combination thereof, may include the electrolyte comprising the compound, the compound represented by Formula 1. The lithium ion battery may include, for example, a cathode, and anode, and a liquid electrolyte disposed between the cathode and the anode, wherein a protective layer including the electrolyte comprising the compound, the compound represented by Formula 1 may be disposed on a surface of the cathode, the anode, or a combination thereof. The lithium ion battery may include, for example, a cathode active material layer, and the cathode active material layer may include a composite cathode active material including: a core including a cathode active material; and a first coating layer disposed on the core, wherein the first coating layer may include the electrolyte comprising the compound, the compound represented by Formula 1. The lithium ion battery may include, for example, an anode active material layer, and the anode active material layer may include a composite anode active material including: a core including an anode active material; and a second coating layer disposed on the core, wherein the second coating layer may include the electrolyte comprising the compound, the compound represented by Formula 1.

The lithium ion battery may be, for example, manufactured as follows.

First, a cathode may be prepared. A cathode active material, a conductive agent, a binder, and a solvent may be mixed to prepare a cathode active material composition. In an embodiment, a cathode active material composition may be directly coated on a cathode current collector and the coated cathode current collector may be dried to prepare a cathode. In an embodiment, the cathode active material composition may be cast on a separate support, and then a film obtained by peeling off from the support may be laminated on a cathode current collector to prepare a cathode. In an embodiment, the cathode active material composition may be prepared in a form of an electrode ink containing an excess of solvent, and then printed on a support by an inkjet method or a gravure printing method to prepare a cathode. A printing method is not limited to the above-described method, and any suitable method available for general coating and printing may be used. On a surface of the cathode active material layer included in the cathode, a cathode protective layer may be formed by coating an electrolyte represented by Formula 1.

The cathode current collector may include a metal substrate. As the metal substrate, for example, a plate or a foil, comprising aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof, may be used. The cathode current collector may be omitted. The cathode current collector may further include a carbon layer disposed on one surface or both surfaces of the metal substrate. When the carbon layer is additionally disposed on the metal substrate, a metal of the metal substrate may be prevented from being corroded by a solid electrolyte included in a cathode layer, and the interfacial resistance between the cathode active material layer and the cathode current collector may be reduced. A thickness of the carbon layer may be, for example, about 0.1 micrometer (μm) to about 5 μm, about 0.1 μm to about 3 μm, or about 0.1 μm to about 1 μm. When the carbon layer is too thin, the contact between the metal substrate and the solid electrolyte may not be completely blocked. When the carbon layer is too thick, the energy density of a lithium battery may be reduced. The carbon layer may include amorphous carbon, crystalline carbon, or a combination thereof.

As the cathode active material, any material suitable for a lithium battery in the art may be used without limitation. For example, the cathode active material may be lithium transition metal oxide, transition metal sulfide, or a combination thereof. For example, at least one composite oxides of lithium, a metal of Co, Mn, Ni, or a combination thereof, may be used, and a specific example thereof may be a compound represented by one of the following formulae: LiₐA_{1-b}B′_{b}D₂ (where 0.9≤a≤1.8 and 0≤b≤0.5); LiₐE_{1-b}B′_{b}O_{2-c}D_{c} (where 0.9≤a≤1.8, 0≤b≤0.5, and 0≤c≤0.05); LiₐE_{2-b}B′_{b}O_{4-c}D_{c} (where 0≤b≤0.5 and 0≤c≤0.05); LiₐNi_{1-b-c}Co_{b}B′_{c}Dₐ (where 0.9≤a≤1.8, 0≤b≤0.5, 0≤c≤0.05, and 0<α≤2); LiₐNi_{1-b-c}Co_{b}B′_{c}O_{2-α}F_{α} (where 0.9≤a≤1.8, 0≤b≤0.5, 0≤c≤0.05, and 0<α≤2); LiₐNi_{1-b-c}Co_{b}B′_{c}O_{2-α}F′₂ (where 0.9≤a≤1.8, ≤b≤0.5, 0≤c≤0.05, and 0<α<2); LiₐNi_{1-b-c}Mn_{b}B′_{c}Dₐ (where 0.9≤a≤1.8, ≤b≤0.5, 0≤c≤0.05, and 0<α≤2); LiₐNi_{1-b-c}Mn_{b}B′_{c}O_{2-α}F_{α} (where 0.9≤a≤1.8, 0≤b≤0.5, 0≤c≤0.05, and 0<α<2); LiₐNi_{1-b-c}Mn_{b}B′_{c}O_{2-α}F′₂ (where 0.9≤a≤1.8, ≤b≤0.5, 0≤c≤0.05, and 0<α<2); LiₐNi_{b}E_{c}G_{d}O₂ (where 0.9≤a≤1.8, 0≤b≤0.9, 0≤c≤0.5, and 0.001≤d≤0.1); LiₐNi_{b}Co_{c}Mn_{d}GeO₂ (where 0.9≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiₐCoG_{b}O₂ (where 0.9≤a≤1.8 and 0.001≤b≤0.1); LiₐMnG_{b}O₂ (where 0.9≤a≤1.8 and 0.001≤b≤0.1); LiₐMn₂G_{b}O₄ (where 0.9≤a≤1.8 and 0.001≤b≤0.1); QO₂; QS₂; LiQS₂; V₂O₅; LiV₂O₂; LiI′O₂; LiNiVO₄; Li_{(3-f)}J₂(PO₄)₃ (were 0≤f≤2); Li_{(3-f)}Fe₂(PO₄)₃ (0≤f≤2); and LiFePO₄. In the formulae above, A may be Ni, Co, Mn, or a combination thereof; B′ may be Al, Ni, Co, Mn, Cr, Fe, Mg, Sr, V, a rare earth element, or a combination thereof; D may be O, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof. For example, the cathode active material may be LiCoO₂, LiMnₓO₂ₓ (where x=1 and 2), LiNi₁₋ₓMnₓO₂ₓ (where 0<x<1), Ni_{1-x-y}CoₓMn_{y}O₂ (where 0≤x≤0.5 and 0≤y≤0.5), LiFePO₄, TiS₂, FeS₂, TiS₃, FeS₃, or a combination thereof. For example, when an electrolyte represented by Formula 1 is coated on a surface of the cathode active material, a side reaction between the cathode active material and an electrolyte may be prevented.

The conductive material may include, for example, carbon black, carbon fiber, graphite, or a combination thereof. The carbon black may be, for example, acetylene black, ketjen black, super P carbon, channel black, furnace black, lamp black, thermal black, or a combination thereof. The graphite may be natural graphite or artificial graphite. A combination including at least one of the foregoing materials may be used. The cathode may further include, in addition to such a carbonaceous conductive agent, an additional conductive agent. Such an additional conductive agent may include: electrically conductive fiber such as metal fiber; metal powder such as carbon fluoride powder, aluminum powder, or nickel powder; conductive whisker, such as zinc oxide or potassium titanate; or a polyethylene derivative. A combination including at least one of the foregoing additional materials may be used. An amount of the conductive material may be in a range of about 1 part by weight to about 10 parts by weight, for example, about 2 parts by weight to about 7 parts by weight, based on a total weight of the cathode active material. When the amount of the conductive material is within the ranges above, for example, about 1 part by weight to about 10 parts by weight, the cathode may have appropriate electrical conductivity.

A binder may improve adhesion of components of the cathode with one another and with a current collector of the cathode. Examples of the binder include polyacrylic acid (PAA), polyvinylidene fluoride, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene monomer (EPDM), sulfonated EPDM, styrene-butadiene-rubber, fluorinated rubber, a copolymer thereof, or a combination thereof. An amount of the binder may be in a range of about 1 part by weight to about 10 parts by weight, for example, about 2 parts by weight to about 7 parts by weight, based on the total weight of the cathode active material. When the amount of the binder is within the ranges above, the adhesion to the cathode current collector of the cathode active material layer may be further improved, and reduction in in energy density of the cathode active material layer may be suppressed.

For use as a solvent, N-methyl pyrrolidone, acetone, water, or a combination thereof, may be used. The amounts of the cathode active material, the conductive agent, the binder, and the solvent may be at levels suitable for use in a lithium battery.

A plasticizer may be added to the cathode active material composition to form a pore in the cathode active material layer.

Next, the anode may be prepared. An anode active material, a conductive agent, a binder, and a solvent may be mixed to prepare an anode active material composition. In an embodiment, an anode active material composition may be directly coated on a copper current collector, and the coated copper current collector may be dried to prepare an anode. In an embodiment, the anode active material composition may be cast on a separate support, and then an anode active material film obtained by peeling off from the support may be laminated on a copper current collector to prepare the anode. In an embodiment, the anode active material composition may be prepared in a form of an electrode ink containing an excess of solvent, and then printed on a support by an inkjet method or a gravure printing method to prepare the anode. A printing method is not limited to the above-described method, and any method available for general coating and printing may be used.

The anode active material may include, for example, a lithium metal, a lithium metal alloy, a metal alloyable with lithium, a transition metal oxide, a non-transition metal oxide, or a carbon-based material. The lithium metal alloy refers to an alloy of lithium and other metals such as indium. Examples of the metal alloyable with lithium include silicon (Si), tin (Sn), aluminum (Al), germanium (Ge), lead (Pb), bismuth (Bi), antimony (Sb), a Si—Y′ alloy (where Y′ is an alkali metal, an alkaline earth metal, a Group 13 element, a Group 14 element, a transition metal, a rare earth element, or a combination thereof, and Y′ is not Si), a Sn—Y′ alloy (where Y′ is an alkali metal, an alkaline earth-metal, a Group 13 element, a Group 14 element, a transition metal, a rare earth element, or a combination thereof, and Y′ is not Sn), or a combination thereof. The element Y′ may be, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. The transition metal oxide may include, for example, a lithium titanium oxide, a vanadium oxide, a lithium vanadium oxide, and the like. The non-transition metal oxide may include, for example, SnO₂, SiOx (where 0<x<2), or a combination thereof. The carbon-based material may include, for example, crystalline carbon, amorphous carbon, or a mixture thereof. The crystalline carbon may be graphite, such as natural graphite or artificial graphite, that is amorphous or in a laminar, flake, spherical, or fiber form. The amorphous carbon may include soft carbon (low-temperature calcined carbon), hard carbon, mesophase pitch carbide, calcined coke, or a combination thereof. The anode active material may include, for example, a lithium metal, a lithium metal alloy, or a combination thereof.

A conductive material, a binder, and a solvent used for manufacturing the anode may be selected from materials used for manufacturing a cathode plate. The amounts of the anode active material, the conductive agent, the binder, and the solvent may be at levels suitable for use in a lithium battery.

A plasticizer may be added to the anode active material composition to form a pore in the anode active material layer.

In an embodiment, a protective layer including the electrolyte comprising the compound, the compound represented by Formula 1 may be disposed on a surface of the anode active material layer. In an embodiment, the anode active material may include an anode active material particle which includes: a core including a lithium metal, a lithium metal alloy, or a combination thereof; and a first coating layer disposed on the core, wherein the first coating layer may include the electrolyte represented by Formula 1. When such a protective layer and/or a coating layer is disposed on the anode, lithium ionic conductivity and/or stability to lithium metal of the anode may be improved.

Next, a separator may be prepared.

The cathode and the anode may be separated by a separator, and any separator generally used in a lithium battery in the art may be used. A separator with a low resistance to movement of ions in an electrolyte and excellent electrolyte wettability may be suitable. The separator may be, for example, a material of glass fiber, polyester, Teflon, polyethylene, polypropylene, polytetrafluoroethylene (PTFE), or a combination thereof, and may have a form of a non-woven fabric or a woven fabric. More particularly, a rollable separator including polyethylene, polypropylene, or a combination thereof, may be used for a lithium ion battery, and a separator with excellent impregnation for an organic electrolyte solution may be used for a lithium ion polymer battery.

The separator may be manufactured as follows. A polymer resin, a filler, and a solvent may be mixed to prepare a separator composition. In an embodiment, the separator composition may be directly coated on an electrode and the coated electrode may be dried, to form a separator film. In an embodiment, the separator composition may be cast on a separate support and the cast support may be dried, and a separator film may be obtained by peeling off from the support. Such a separator film may be then laminated on an electrode to form the separator. The polymer resin is not particularly limited, and any material suitable as a binder for an electrode plate may be used. For example, a vinylidene fluoride/hexafluoropropylene copolymer, polyvinylidene fluoride, polyacrylonitrile, polymethylmethacrylate, or a mixture thereof may be used as the polymer resin. For example, use of a vinylidene fluoride/hexafluoropropylene copolymer including hexafluoropropylene in an amount of about 8 weight percent (wt %) to about 25 wt % may be suitable.

Next, a liquid electrolyte may be prepared.

The liquid electrolyte may be an organic electrolyte solution containing an organic solvent. The organic electrolyte solution may be prepared by dissolving a lithium salt in an organic solvent. For use as an organic solvent, any suitable organic solvent available in the art may be used. The organic solvent may be, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyl tetrahydrofuran, γ-butyrolactone, dioxolan, 4-methyl dioxolan, N, N-dimethyl formamide, dimethyl acetamide, dimethyl sulfoxide, dioxane, 1,2-dimethoxyethane, sulfolane, dichloroethane, chlorobenzene, nitrobenzene, diethylene glycol, dimethyl ether, or a mixture thereof. For use as the lithium salt, any lithium salt suitable in the art may be used. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂)(where x and y may be different from each other, and may each independently be an integer of 1 to 20), LiCl, LiI, or any mixture thereof. A concentration of the lithium salt may be about 0.1 molar (M) to about 10 M, but is not necessarily limited thereto, and may be appropriately changed within a range that improved battery performance may be provided. The liquid electrolyte may additionally include, for example, a flame retardant such as a phosphorus-based flame retardant or a halogen-based flame retardant.

Referring to FIG. 6, a lithium battery 1 according to an embodiment includes a cathode 3, an anode 2, and a separator 4. The cathode 3, the anode, and the separator 4 may be wound or folded to form a battery structure 7. The formed battery structure 7 may be accommodated in a battery case 5. A composition for forming a cathode electrolyte may be injected into the battery case 5, crosslinked, and then sealed with a cap assembly 6 to complete the manufacture of the lithium ion battery 1. The battery case 5 may be cylindrical, but the shape of the battery case 5 is not necessarily limited thereto. For example, the battery case 5 may be a square-type, or a thin-film type.

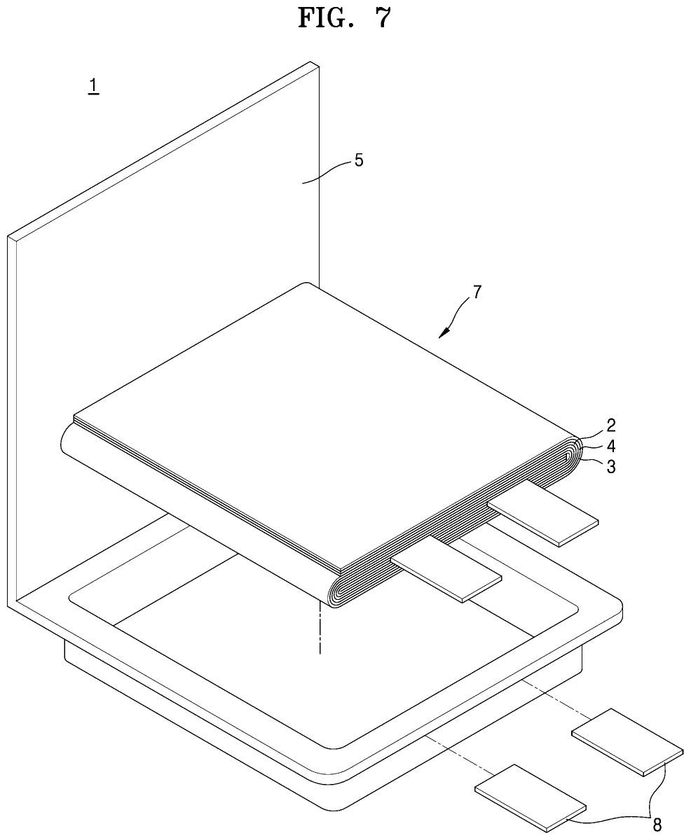

Referring to FIG. 7, the lithium battery 1 according to an embodiment includes the cathode 3, the anode 2, and the separator 4. The separator 4 may be disposed between the cathode 3 and the anode 2, and the cathode 3, the anode 2, and the separator 4 may be wound or folded to form the battery structure 7. The formed battery structure 7 may be accommodated in the battery case 5. The lithium battery 1 may include an electrode tab 8 serving as an electrical path for inducing a current formed in the battery structure 7 to the outside. A composition for forming a cathode electrolyte may be injected into the battery case 5, crosslinked, and then sealed to complete the manufacture of the lithium ion battery 1. The battery case 5 may be a square-type, but the shape of the battery case 5 is not necessarily limited thereto. For example, the battery case 5 may be a cylindrical-type, or a thin-film type.

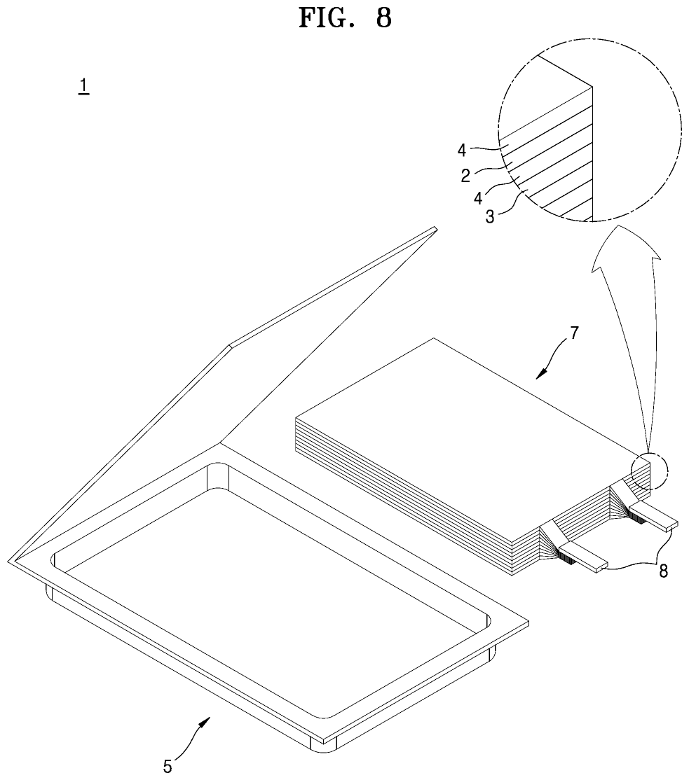

Referring to FIG. 8, the lithium battery 1 according to an embodiment includes the cathode 3, the anode 2, and the separator 4. The separator 4 may be disposed between the cathode 3 and the anode 2 to form the battery structure 7. The battery structure 7 may be stacked in a bi-cell structure, and then accommodated in the battery case 5. The lithium battery 1 may include the electrode tab 8 serving as an electrical path for inducing a current formed in the battery structure 7 to the outside. A composition for forming a cathode electrolyte may be injected into the battery case 5, crosslinked, and then sealed to complete the manufacture of the lithium ion battery 1. The battery case 5 may be a square-type, but the shape of the battery case 5 is not necessarily limited thereto. For example, the battery case 5 may be a cylindrical-type, or a thin-film type.

A pouch-type lithium ion battery uses a pouch as a case of the lithium ion battery shown in FIGS. 6 to 8. The pouch-type lithium ion battery may include at least one battery structure. A separator may be disposed between a cathode and an anode to provide a battery structure. A plurality of battery assemblies may be stacked in the thickness direction, impregnated with an organic electrolyte solution, accommodated in a pouch, and then sealed to complete the manufacture of a pouch-type lithium battery. For example, although not shown in the drawings, the above-described cathode, anode, and separator may be simply stacked and accommodated in a pouch in the form of an electrode assembly, or may be wound or folded into an electrode assembly in the form of a jelly roll to be then accommodated in a pouch. Next, a composition for forming a cathode electrolyte may be injected into the pouch, thermally crosslinked, and then sealed to complete the manufacture of the lithium ion battery.

The lithium ion battery may have excellent characteristics in terms of discharge capacity and lifespan and have high energy density, and thus may be used, for example, in an electric vehicle (EV). For example, the lithium ion battery may be used in a hybrid vehicle, such as a plug-in hybrid electric vehicle (PHEV). In addition, the lithium ion battery may be applicable to the fields requiring high-power storage. For example, the lithium ion battery may be used in an electric bicycle, or a power tool.

Multiple lithium ion batteries may be stacked to form a battery module, and multiple battery modules may form a battery pack. The battery pack may be used in a device that requires high capacity and large output. For example, the battery pack may be used in a laptop computer, a smart phone, or an EV. The battery module may include, for example, multiple batteries and a frame that holds the multiple batteries. The battery pack may include, for example, multiple battery modules and a bus bar that connects the battery modules together. The battery module and/or battery pack may further include a cooling device. The multiple battery packs may be managed by a battery management system. The battery management system may include a battery pack and an electronic control device connected to the battery pack.

### (All-Solid-State Battery)

An all-solid-state battery may be, for example, a battery including a solid electrolyte. The all-solid-state battery may include the electrolyte comprising the compound, the compound represented by Formula 1.

The all-solid-state battery may include: a cathode including a cathode active material; an anode including an anode active material; and a solid electrolyte disposed between the cathode and the anode, wherein the cathode, the anode, or a combination thereof, may include the electrolyte comprising the compound, the compound represented by Formula 1. The all-solid-state battery may include, for example, a cathode active material layer, and the cathode active material layer may include the electrolyte comprising the compound, the compound represented by Formula 1. The all-solid-state battery may include, for example, an anode active material layer, and the anode active material layer may include the electrolyte comprising the compound, the compound represented by Formula 1. The all-solid-state battery may include a solid electrolyte disposed between the cathode and the anode, and the solid electrolyte may include the electrolyte comprising the compound, the compound represented by Formula 1. The all-solid-state battery may include, for example, a cathode active material layer, and the cathode active material layer may include a composite cathode active material including: a core including a cathode active material; and a first coating layer disposed on the core, wherein the first coating layer may include the electrolyte represented by Formula 1. The all-solid-state battery may include, for example, an anode active material layer, and the anode active material layer may include a composite anode active material including: a core including an anode active material; and a second coating layer disposed on the core, wherein the second coating layer may include the electrolyte comprising the compound, the compound represented by Formula 1.

### (Type 1: All-Solid-State Battery Employing Non-Precipitating Anode)

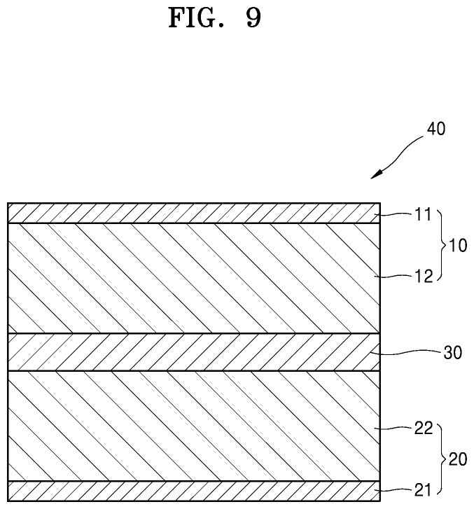

FIG. 9 is a schematic diagram of an all-solid-state battery including a non-precipitating anode according to an embodiment. In the all-solid-state battery including a non-precipitating anode, an initial charging capacity of the anode active material layer during initial charging may be, for example, greater than about 50%, greater than or equal to about 60%, greater than or equal to about 70%, greater than or equal to about 80%, greater than or equal to about 90%, or greater than or equal to about 100%, of an initial charging capacity of the cathode active material layer. In an aspect, the initial charging capacity of the anode active material layer may be, about 50% to about 200%, about 60% to about 200%, about 70% to about 200%, about 80% to about 200%, about 90% to about 200%, or about 100% to about 200%, of the initial charging capacity of the cathode active material layer.

The all-solid-state lithium battery may be manufactured as follows.

First, a solid electrolyte layer may be prepared. The solid electrolyte layer may include a solid electrolyte. The solid electrolyte layer may be prepared by, for example, mixing and drying the electrolyte comprising the compound, the compound represented by Formula 1 and a binder, or by pressing powders of the electrolyte powder comprising the compound, the compound represented by Formula 1 in a certain form. The solid electrolyte layer may be prepared by, for example, mixing and drying the electrolyte comprising the compound, the compound represented by Formula 1, an oxide-based (e.g., oxide-containing) solid electrolyte, and a binder, or by pressing powders of the electrolyte powder comprising the compound, the compound represented by Formula 1 and powders of the oxide-based solid electrolyte in a certain form. The solid electrolyte layer may be prepared by, for example, mixing and drying an oxide-based solid electrolyte and a binder, or by pressing powders of a different oxide-based solid electrolyte in a certain form. The solid electrolyte layer may be prepared by, for example, mixing and drying a sulfide-based (e.g., sulfide-containing) solid electrolyte and a binder, or by pressing powders of the sulfide-based solid electrolyte in a certain form.

The solid electrolyte may be deposited by using a film-forming method, such as blasting, aerosol deposition, cold spraying, sputtering, chemical vapor deposition (CVD), or spraying, and a solid electrolyte layer may be prepared thereby. In addition, the solid electrolyte layer may be formed by pressurizing the solid electrolyte. In addition, the solid electrolyte layer may be formed by mixing and pressurizing the solid electrolyte, the solvent, and the binder or a support. In this case, the solvent or support may be added to reinforce the strength of the solid electrolyte layer or to prevent short-circuit of the solid electrolyte.

The binder included in the solid electrolyte layer may include, for example, styrene butadiene rubber (SBR), polytetrafluoroethylene, polyvinylidene fluoride, polyethylene, polyvinyl alcohol, or a combination thereof, but is not limited thereto. Any material suitable as a binder in the art may be used. The binder included in the solid electrolyte layer may be the same as or different from the binder included in the cathode layer and the anode layer.

The oxide-based solid electrolyte may include, for example, Li_{1+x+y}AlₓTi₂₋ₓSi_{y}P_{3-y}O₁₂ (where 0<x<2 and 0≤y<3), BaTiO₃, Pb(ZrₚTi₁₋ₚ)O₃ (PZT, 0≤p≤1), Pb₁₋ₓLaₓZr_{1-y}Ti_{y}O₃ (PLZT, where 0≤x<1 and 0≤y<1), Pb(Mg_{1/3}Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1+x+y}(AlₚGa₁₋ₚ)ₓ(Ti_{q}Ge_{1-q})₂₋ₓSi_{y}P_{3-y}O₁₂ (where 0≤x≤1, 0≤y≤1, 0≤p≤1, and 0≤q≤1), LiₓLa_{y}TiO₃ (where 0<x<2 and 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (where M may be Te, Nb, or Zr, and x may be an integer from 1 to 10). The solid electrolyte may be prepared by a sintering method. The oxide-based solid electrolyte may include, for example, a garnet-type solid electrolyte Li₇La₃Zr₂O₁₂ (LLZO), Li₃₊ₓLa₃Zr₂₋ₐMₐO₁₂ (M-doped LLZO, where M may be Ga, W, Nb, Ta, or Al, and x may be an integer from 1 to 10), or a combination thereof.

The sulfide-based solid electrolyte may include, for example, lithium sulfide, silicon sulfide, phosphorus sulfide, boron sulfide, or a combination thereof. Particles of the sulfide-based solid electrolyte may include Li₂S, P₂S₅, SiS₂, GeS₂, B₂S₃, or a combination thereof. The particle of the sulfide-based solid electrolyte particle may include Li₂S or P₂S₅. The particle of the sulfide-based solid electrolyte particle is known to have higher lithium ionic conductivity than other inorganic compounds. For example, the sulfide-based solid electrolyte may include Li₂S and P₂S₅. When a sulfide solid electrolyte material of the sulfide-based solid electrolyte includes Li₂S—P₂S₅, a molar ratio of Li₂S to P₂S₅ may be, for example, in a range of about 50:50 to about 90:10. The sulfide-based solid electrolyte may also include an inorganic solid electrolyte prepared by adding Li₃PO₄, halogen, a halogen compound, Li₂₊₂ₓZn₁₋ₓGeO₄ (“LISICON”), Li_{3+y}PO₄₋ₓNₓ (“LIPON”), Li_{3.25}Ge_{0.25}P_{0.75}S₄ (“ThioLISICON”), Li₂O—Al₂O₃—TiO₂—P₂O₅ (“LATP”), or a combination thereof, to an inorganic solid electrolyte, such as Li₂S—P₂S₅, SiS₂, GeS₂, B₂S₃, or a combination thereof. Non-limiting examples of the sulfide-based solid electrolyte material may be: Li₂S—P₂S₅; Li₂S—P₂S₅—LiX (where X may be a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (where m and n may each be a positive number, and Z may be Ge, Zn, or Ga); Li₂S—GeS₂; Li₂S—SiS₂—Li₃PO₄; Li₂S—SiS₂-LiₚMO_{q} (where p and q may each be a positive number, and M may be P, Si, Ge, B, Al, Ga, or In); or a combination thereof. In this regard, such a sulfide-based solid electrolyte material may be prepared by treating a raw starting material of the sulfide-based solid electrolyte material (e.g., Li₂S, or P₂S₅) by a melt quenching method, a mechanical milling method, or a combination thereof. Also, a calcination process may be performed after the treatment.

Next, a cathode may be prepared.

A cathode active material layer including a cathode active material may be formed on a cathode current collector to prepare the cathode. The cathode active material layer may be prepared by a vapor phase method or a solid phase method. The vapor phase method may include pulse laser deposition (PLD), sputtering deposition, chemical vapor deposition (CVD), or a combination thereof, but is not limited thereto. Any method suitable in the art may be used. The solid-phase method may include a sintering method, a sol-gel method, a doctor blade method, a screen printing method, a slurry casting method, a powder pressing method, or a combination thereof, but is not necessarily limited thereto. Any method suitable in the art may be used.

The cathode active material layer may include a cathode active material. The cathode active material and cathode current collector may be selected from materials used in the above-described lithium ion battery.

The cathode active material layer may additionally include a binder, a conductive material, or a combination thereof. The binder and conductive material may be selected from materials used in the above-described lithium ion battery.

The cathode active material layer may include the electrolyte comprising the compound, the compound represented by Formula 1. A protective layer including the electrolyte comprising the compound, the compound represented by Formula 1 may be disposed on the cathode active material layer.

Next, an anode may be prepared.

The anode may be prepared in the same manner as in the cathode, except that an anode active material is used instead of the cathode active material. An anode active material layer including an anode active material may be formed on an anode current collector to prepare the anode.

The anode active material layer may include an anode active material. The anode active material may be selected from materials used in the above-described lithium ion battery. The anode active material may include, for example, a lithium metal, a lithium metal alloy, or a combination thereof.

The anode active material layer may additionally include a binder, a conductive material, or a combination thereof. The binder and conductive material may be selected from materials used in the above-described lithium ion battery.

The anode active material layer may include the electrolyte represented by Formula 1. A protective layer including the electrolyte represented by Formula 1 may be disposed on the anode active material layer.

Referring to FIG. 9, an all-solid-state battery 40 includes a solid electrolyte layer 30, a cathode 10 disposed on a first surface of the solid electrolyte layer 30, and an anode 20 disposed on a second surface of the solid electrolyte layer 30. The cathode 30 includes a cathode active material layer 12 in contact with the solid electrolyte layer 30 and a cathode current collector 11 in contact with the cathode active material layer 12, and the anode 20 includes an anode active material layer 22 in contact with the solid electrolyte layer 30 and an anode current collector 11 in contact with the anode active material layer 22. In an embodiment, the all-solid-state secondary battery 40 may be formed in a way that, for example, the cathode active material layer 12 and the anode active material layer 22 are respectively formed on both surfaces of the solid electrolyte layer 30, and then the cathode current collector 11 and the anode current collector 21 are respectively formed the cathode active material layer 12 and the anode active material layer 22. In an embodiment, the anode active material layer 22, the solid electrolyte layer 30, the cathode active material layer 12, and the cathode current collector 11 may be stacked in the stated order on the anode current collector 21 to complete the manufacture of the all-solid-state battery 40.

### (Type 2: All-Solid-State Battery Employing Precipitating Anode)

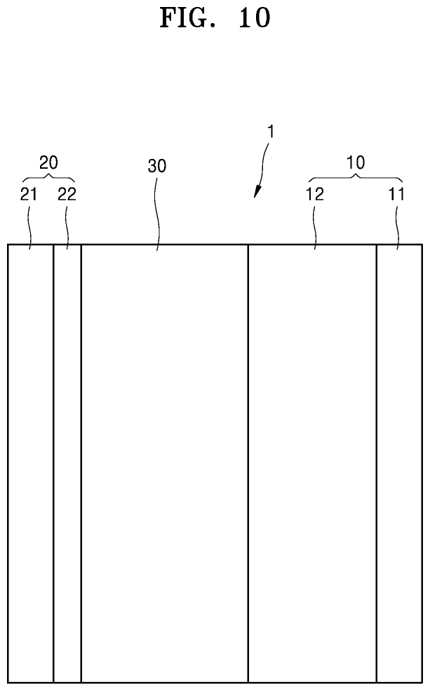

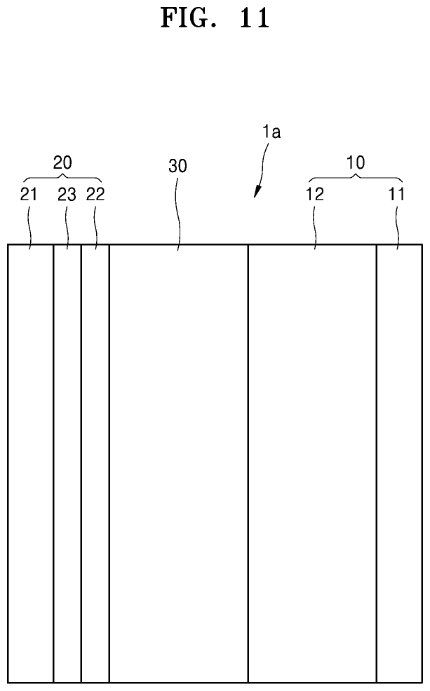

FIGS. 10 and 11 are each a schematic diagram of an all-solid-state battery including a precipitating anode according to an embodiment. In the all-solid-state battery including a precipitating anode, the initial charging capacity of the anode active material layer during initial charging may be, for example, less than or equal to about 50%, less than or equal to about 40%, less than or equal to about 30%, or less than or equal to about 20%, of the initial charging capacity of the anode active material layer. In an aspect, the initial charging capacity of the anode active material layer during initial charging may be, about 1% to about 50%, about 1% to about 40%, about 1% to about 30%, or about 1% to about 20%. An all-solid-state secondary battery 1 includes: for example, a cathode layer 10 including a cathode active material layer 12 disposed on a cathode current collector 11; an anode layer 20 including an anode active material layer 22 disposed on an anode current collector 21; and an electrolyte layer 30 disposed between the cathode layer 10 and the anode layer 20, wherein the cathode active material layer 12 and/or the electrolyte layer 30 includes a solid electrolyte.

An all-solid-state battery according to another embodiment may be manufactured as follows.

The cathode and electrolyte layer may be prepared in the same manner as in the above-described all-solid-state secondary battery employing the non-precipitating anode.

Next, an anode may be prepared.

Referring to FIGS. 10 and 11, the anode layer 20 includes the anode current collector 21 and the anode active material layer 22 disposed on the anode current collector 21, and the anode active material layer 22 may include, for example, an anode active material and a binder.

The anode active material included in the anode active material layer 22 may have, for example, a particle shape. An average particle diameter of the anode active material having a particle shape may be, for example, less than or equal to about 4 micrometers (μm), less than or equal to about 2 μm, less than or equal to about 1 μm, or less than or equal to about 900 nanometers (nm). The average particle diameter of the anode active material having a particle shape may be, for example, in a range of about 10 nm to about 4 μm, about 10 nm to about 3 μm, about 10 nm to about 2 μm, about 10 nm to about 1 μm, or about 10 nm to about 900 nm. When the anode active material has the average particle diameter within the ranges above, lithium may be more easily subjected to reversible absorbing and/or desorbing during charge and discharge. The average particle diameter of the anode active material may be, for example, a median diameter D50 measured by using a laser particle size distribution meter.

The anode active material included in the anode active material layer 22 may include, for example, a carbon-based anode active material, a metallic or metalloid anode active material, or a combination thereof.

The carbon-based anode active material may be, in particular, amorphous carbon. The amorphous carbon may include, for example carbon black (CB), acetylene black (AB), furnace black (FB), ketjen black (KB), graphene, or a combination thereof, but is not necessarily limited thereto. Any material categorized as amorphous carbon in the art may be used. The amorphous carbon is carbon that has no or very low crystallinity, and in this regard, may be distinguished from crystalline carbon or graphite-based carbon.

The metallic or metalloid anode active material may include gold (Au), platinum (Pt), palladium (Pd), silicon (Si), silver (Ag), aluminum (Al), bismuth (Bi), tin (Sₙ), zinc (Zn), or a combination thereof, but is not necessarily limited thereto. Any suitable material available as a metallic anode active material or metalloid anode active material capable of forming an alloy or compound with lithium in the art may be used. For example, since nickel (Ni) does not form an alloy with lithium, Ni is not a metallic anode active material.

The anode active material layer 22 may include one type of the anode active material from among the anode active materials described above, or a mixture of multiple anode active materials that are different from each other. In an embodiment, the anode active material layer 22 may include only amorphous carbon, or may include Au, Pt, Pd, Si, Ag, Al, Bi, Sₙ, Zn, or a combination thereof. In an embodiment, the anode active material layer 22 may include a mixture of amorphous carbon with Au, Pt, Pd, Si, Ag, Al, Bi, Sₙ, Zn, or a combination thereof. A mixing ratio of the amorphous carbon to metal in the mixture may be, for example, as a weight ratio, in a range of about 10:1 to about 1:2, about 5:1 to about 1:1, or about 4:1 to about 2:1, but is not necessarily limited thereto. The mixing ratio may be chosen according to the characteristics of the all-solid-state secondary battery 1. When the anode active material has such a composition, cycle characteristics of the all-solid-state secondary battery 1 may be further improved.

The anode active material included in the first anode active material layer 22 may include, for example, a mixture of a first particle comprising amorphous carbon and a second particle comprising a metal or metalloid. The metal or metalloid may include, for example, Au, Pt, Pd, Si, Ag, Al, Bi, Sₙ, Zn, or a combination thereof. The metalloid may be, in other words, a semiconductor. An amount of the second particle may be in a range of about 8 wt % to about 60 wt %, about 10 wt % to about 50 wt %, about 15 wt % to about 40 wt %, or about 20 wt % to about 30 wt %, based on a total weight of the mixture. When the amount of the second particle is within the ranges above, for example, the cycle characteristics of the all-solid-state secondary battery 1 may be further improved.

The binder included in the anode active material layer 22 may include, for example, SBR, polytetrafluoroethylene, polyvinylidene fluoride, polyethylene, vinylidene fluoride/hexafluoropropylene copolymer, polyacrylonitrile, polymethyl methacrylate, or a combination thereof, but is not necessarily limited thereto. Any suitable material available as a binder in the art may be used. The binder may be used alone, or may be used with multiple binders that are different from each other.

When the anode active material layer 22 includes the binder, the anode active material layer 22 may be stabilized on the anode current collector 21. In addition, despite a change in volume and/or relative position of the anode active material layer 22 during charge and discharge, cracking of the anode active material layer 22 may be suppressed. For example, when the anode active material layer 22 does not include the binder, the anode active material layer 22 may be easily separated from the anode current collector 21. At a portion where the anode current collector 21 is exposed by the separation of the anode active material layer 22 from the anode current collector 22, the possibility of occurrence of a short circuit may increase as the anode current collector 21 is in contact with the electrolyte layer 30. The anode active material layer 22 may be prepared by, for example, coating the anode current collector 21 with a slurry in which a material of the anode active material layer 22 is dispersed, and then drying the coated anode current collector 21. When the anode active material layer 22 includes the binder, the anode active material may be stably dispersed in the slurry. For example, when the anode current collector 21 is coated with the slurry by a screen printing method, clogging of the screen (for example, clogging by an agglomerate of the anode electrode active material) may be suppressed.

The anode active material layer 22 may further include additives, for example, a filler, a coating agent, a dispersant, an ionic conductive auxiliary agent, or a combination thereof, as used in the conventional all-solid-state secondary battery 1.

A thickness of the anode active material layer 22 may be, for example, less than or equal to about 50%, less than or equal to about 40%, less than or equal to about 30%, less than or equal to about 20%, less than or equal to about 10%, or less than or equal to about 5%, of a thickness of the cathode active material layer 12. In an aspect, the thickness of the anode active material layer 22 may be, about 0.1% to about 30%, about 0.1% to about 20%, about 0.1% to about 10%, about 0.1% to about 5%, of the thickness of the cathode active material layer 12. The thickness of the anode active material layer 22 may be, for example, in a range of about 1 μm to about 20 μm, about 2 μm to about 10 μm, or about 3 μm to about 7 μm. When the anode active material layer 22 is too thin, lithium dendrites formed between the anode active material layer 22 and the anode current collector 21 may collapse the anode active material layer 22, and thus the cycle characteristics of the all-solid-state battery 1 may be difficult to improve. When the anode active material layer 22 is too thick, the energy density of the all-solid-state battery 1 may be lowered and the internal resistance of the all-solid-state battery 1 by the anode active material layer 22 may increase, and thus the cycle characteristics of the all-solid-state battery 1 may be difficult to improve.

When the thickness of the anode active material layer 22 is reduced, for example, a charging capacity of the anode active material layer 22 may be also reduced. The charging capacity of the anode active material layer 22 may be, for example, less than or equal to about 50%, less than or equal to about 40%, less than or equal to about 30%, less than or equal to about 20% or, less than or equal to about 10%, or less than or equal to about 5%, with respect to a charging capacity of the cathode active material layer 12. The charging capacity of the anode active material layer 22 may be, for example, in a range of about 0.1% to about 50%, about 0.1% to about 40%, about 0.1% to about 30%, about 0.1% to about 20%, about 0.1% to about 10%, about 0.1% to about 5%, or about 0.1% to about 2%, with respect to the charging capacity of the cathode active material layer 12. When the charging capacity of the anode active material layer 22 is significantly small, the anode active material layer 22 becomes very thin. In this regard, lithium dendrites formed between the anode active material layer 22 and the anode current collector 21 during a repeated process of charging and discharging may collapse the anode active material layer 22, and thus the cycle characteristics of the all-solid-state battery 1 may be difficult to improve. When the charging capacity of the anode active material layer 22 is excessively increased, the energy density of the all-solid-state battery 1 may be lowered and the internal resistance of the all-solid-state battery 1 by the anode active material layer 22 may increase, and thus the cycle characteristics of the all-solid-state battery 1 may be difficult to improve.

A charging capacity of the cathode active material layer 12 may be obtained by multiplying the charging specific capacity (milliampere-hours per gram, mAh/g) of the cathode active material by the mass of the cathode active material in the cathode active material layer 12. When several types of the cathode active material are used, for each cathode active material, the charging specific capacity is multiplied by the mass, and the sum of these values is the charging capacity of the cathode active material layer 12. A charging capacity of the anode active material layer 22 may be calculated in the same way. That is, the charging capacity of the anode material layer 22 may be obtained by multiplying the charging specific capacity (mAh/g) of the anode active material 22 by the mass of the anode active material in anode active material layer 22. When several types of the anode active material are used, for each anode active material, the charging specific capacity is multiplied by the mass, and the sum of these values is the charging capacity of the anode active material layer 22. Here, the charging specific capacities of the cathode active material and the anode active material are capacities estimated by using an all-solid-state half-cell using lithium metal as a counter electrode. The charging capacities of the cathode active material layer 12 and the anode active material layer 22 may be directly measured by measuring the charging capacity obtained by using the all-solid-state half-cell. When the measured charging capacity is divided by the mass of each active material, the charging specific capacity is obtained. In an embodiment, the charging capacities of the cathode active material layer 12 and the anode active material layer 22 may be initial charging capacities measured during the first cycle of charging.

Referring to FIG. 11, an all-solid-state battery 1a may further include, for example, a metal layer 23 disposed between the anode current collector 21 and the anode active material layer 22. The metal layer 23 may be a metal foil or a plated metal layer. The metal layer 12 may include Li or a Li alloy. Thus, the metal layer 23 may act as, for example, a Li reservoir. The Li alloy may include, for example, a Li—Al alloy, a Li—Sₙ alloy, a Li—In alloy, a Li—Ag alloy, a Li—Au alloy, a Li—Zn alloy, a Li—Ge alloy, a Li—Si alloy, or a combination thereof, but is not limited thereto. Any suitable material alloyable with Li in the art may be used. The metal layer 23 may comprise one of these alloys or lithium, or may comprise several types of alloy.

A thickness of the metal layer 23 is not particularly limited, but may be, for example, in a range of about 1 μm to about 200 μm, about 1 μm to about 100 μm, about 1 μm to about 70 μm, about 1 μm to about 50 μm, about 1 μm to about 30 μm, or about 1 μm to about 20 μm. When the metal layer 23 is too thin, the metal layer 23 may have a difficulty in performing a function as a Li reservoir. When the metal layer 23 is too thick, the mass and volume of the all-solid-state battery 1a may be increased, and thus the cycle characteristics of the all-solid-state battery 1a may be rather degraded. The metal layer 23 may be, for example, a metal foil having a thickness within the ranges above.

In the all-solid-state battery 1a, the metal layer 23 may be, for example, disposed between the anode current collector 21 and the anode active material layer 22 before assembly of the all-solid-state battery 1, or may be precipitated between the anode current collector 21 and the anode active material layer 22 by charging after assembly of the all-solid-state battery 1a. When the metal layer 23 is disposed between the anode current collector 21 and the anode active material layer 22 before assembly of the all-solid-state battery 1a, the metal layer 23, which includes Li, may serve as a Li reservoir. For example, a Li foil may be disposed between the anode current collector 21 and the anode active material layer 22 before assembly of the all-solid-state battery 1a. Accordingly, the cycle characteristics of the all-solid-state battery 1a including the metal layer 23 may be further improved. When the metal layer 23 is precipitated by charging after assembly of the all-solid-state battery 1a, the energy density of the all-solid-state battery 1a, which does not include the metal layer 23 at the time of assembly of the all-solid-state battery 1a, may increase. For example, during charge of the all-solid-state battery 1, the all-solid-state battery 1 may be charged in excess of the charging capacity of the anode active material layer 22. That is, the anode active material layer 22 may be overcharged. At the beginning of charging, Li may be adsorbed onto the anode active material layer 22. The anode active material included in the anode active material layer 22 may then form an alloy or a compound with Li ions that have transported from the cathode layer 10. When the charging is performed in excess of the capacity of the anode active material layer 22, for example, Li may be precipitated on a rear surface of the anode active material layer 22, i.e., a surface between the anode current collector 21 and the anode active material layer 22, and due to the precipitated Li, a metal layer corresponding to the metal layer 23 may be formed. The metal layer 23 may be a metal layer mainly comprising lithium (i.e., lithium metal). Such a result may be obtained, for example, when the anode active material included in the anode active material layer 22 comprises a material that forms an alloy or a compound with Li. During discharge, Li included in the anode active material layer 22 and the metal layer 23 may be ionized and migrate toward the cathode layer 10. In this regard, Li may be used as the anode active material in the all-solid-state battery 1. In addition, since the anode active material layer 22 coats the metal layer 23, the anode active material layer 22 may serve as a protective layer for the metal layer 23, and may serve to suppress the precipitation growth of lithium dendrites. Therefore, the short circuit and the capacity degradation of the all-solid-state battery 1 may be suppressed, and consequently, the cycle characteristics of the all-solid-state battery 1 may be improved. In addition, when the metal layer 23 is disposed by charging after assembly of the all-solid-state battery 1, the anode current collector 21, the anode active material layer 22, and a region therebetween may be, for example, Li-free regions that do not include Li in an initial state or a post-discharge state of the all-solid-state battery 1.

The anode current collector 21 may be formed of, for example, a material that does not react with Li, that is, a material that forms neither an alloy nor a compound with Li. A material for forming the anode current collector 21 may be, for example, copper (Cu), stainless steel, titanium (Ti), iron (Fe), cobalt (Co), nickel (Ni), or a combination thereof, but is not limited thereto. Any material available as an electrode current collector in the art may be used. The anode current collector 21 may be formed of one of the above-described metals, an alloy of two or more of the above-described metals, or a coating material. The anode current collector 21 may be, for example, in a form of a plate or foil.

The all-solid-state battery 1 may further include, for example, a thin film (not shown), which includes an element capable of forming an alloy with Li, on the anode current collector 21. The thin film may be disposed between the anode current collector 21 and the anode active material layer 22. The thin film may include, for example, an element capable of forming an alloy with Li. The element capable of forming an alloy with Li may include, for example, Au, Ag, Zn, Sₙ, In, Si, Al, Bi, or a combination thereof, but is not necessarily limited thereto. Any suitable element capable of forming an alloy with lithium in the art may be used. The thin film may be formed of one of these metals or an alloy of several types of metals. By disposing the thin-film on the anode current collector 21, for example, a precipitation shape of the metal layer 23 precipitated between the thin film and the anode active material layer 22 may be further flattened, and accordingly, the cycle characteristics of the all-solid-state battery 1 may be further improved.

A thickness of the thin film may be, for example, in a range of about 1 nm to about 800 nm, about 10 nm to about 700 nm, about 50 nm to about 600 nm, or about 100 nm to about 500 nm. When the thickness of the thin film is less than 1 nm, the thin film may have a difficulty in exhibiting a function thereof. When the thin film is too thick, the thin film itself may adsorb Li so that an amount of Li precipitated in the anode may be decreased, and accordingly, the energy density and the cycle characteristics of the all-solid-state battery 1 may be degraded. The thin film may be disposed on the anode current collector 21 by, for example, a vacuum deposition method, a sputtering method, a plating method, or a combination thereof, but is not necessarily limited thereto. Any suitable method capable of forming a thin film in the art may be used.

### (Multilayer Ceramic (MLC) Battery)

The MLC battery may include: for example, multiple cathode layers; multiple anode layers alternately disposed between the multiple cathode layers; and solid electrolyte layers alternately disposed between the multiple cathode layers and the multiple anode layers. The solid electrolyte included in the MLC battery may be, for example, an oxide-based solid electrolyte. The solid electrolyte may include the electrolyte represented by Formula 1.

The MLC battery may include, for example, a sintered product of a stacked body in which a cathode active material precursor, an anode active material precursor, and a solid electrolyte precursor are sequentially stacked, or may be a sintered product of a stacked body in which a cathode active material, an anode active material and a solid electrolyte are sequentially stacked. The MLC battery may have, for example, a stacked body structure in which multiple unit cells are stacked so that a cathode active material layer and an anode active material layer face each other, the unit cell including: a cathode active material layer; a solid electrolyte layer; and an anode layer including an anode active material layer. The MLC battery may further include, for example, a cathode current collector and/or an anode current collector. When the MLC battery includes a cathode current collector, the cathode active material layer may be disposed on both surfaces of the cathode current collector. When the MLC battery includes an anode current collector, the anode active material layer may be disposed on both surfaces of the anode current collector. When the MLC battery further includes the cathode current collector and/or the anode current collector, high rate characteristics of the MLC battery may be further improved. In the MLC battery, unit cells may be stacked by providing a current collector layer on either or both of the uppermost layer and the lowermost layer of the stacked body, or by interposing a metal layer in the stacked body. The MLC battery or a thin-film battery may be, for example, a small or ultra-small battery applicable as a power source for applications of the Internet of Things (IoT) or a power source for a wearable device. The MLC battery or a thin-film battery may be, for example, applicable in medium and large-sized batteries, such as in Evs, or energy storage systems (ESSs).

The anode included in the MLC battery may include, for example, at least one anode active material of lithium metal phosphate oxide, lithium metal oxide, metal oxide, or a combination thereof. The anode active material may include, for example, a compound of Li_{4/3}Ti_{5/3}O₄, LiTiO₂, LiM1ₛM2ₜOᵤ (where M1 and M2 may each be a transition metal, and s, t, and u may each be any positive number), TiOₓ (where 0<x≤3), and LiₓV₂(PO₄)₃ (where 0<x≤5). The anode active material may include, in particular, Li_{4/3}Ti_{5/3}O₄, LiTiO₂, or a combination thereof.

The cathode included in the MLC battery may include a cathode active material. The cathode active material may be selected from cathode active materials used in the above-described lithium ion battery. The cathode active material may include, for example, lithium metal phosphate oxide, lithium metal oxide, or a combination thereof. The cathode active material may include, for example, lithium cobalt oxide, lithium iron phosphate oxide, lithium nickel cobalt manganese oxide, lithium nickel cobalt aluminum oxide, lithium nickel cobalt manganese aluminum oxide, or a combination thereof.

A current collector layer may be used in all cases when it functions as the cathode current collector and/or the anode current collector. The current collector layer may comprise, for example, any metal among Ni, Cu, Ag, Pd, Au, Pt, or a combination thereof. The current collector layer may comprise, for example, an alloy including any metal among Ni, Cu, Ag, Pd, Au, Pt, or a combination thereof. The alloy may be, for example, an alloy of two or more metals of Ni, Cu, Ag, Pd, Au or Pt. The alloy may be, for example, an Ag/Pd alloy. Such a metal or alloy may be used alone, or may be used as a mixture of two or more metals. A current collector layer as the cathode current collector and a current collector layer as the anode current collector may be formed by using the same or different materials. In the Ag/Pd alloy or mixed powder thereof, a melting point may be continuous from a melting point of Ag (962° C.) to a melting point of Pd (1,550° C.) depending on a mixing ratio, and may randomly change. In this regard, the melting point may be adjusted to a sintering temperature at once, and due to high electronic conductivity, an increase in the internal resistance of the MLC battery may be suppressed.

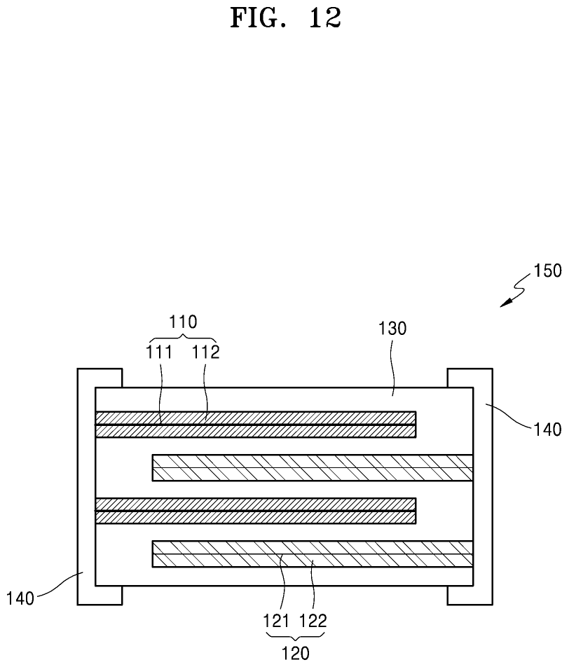

The solid electrolyte may be, for example, an oxide-based solid electrolyte. The oxide-based solid electrolyte may be selected from materials used in the above-described all-solid-state battery. The solid electrolyte may be, for example, a lithium compound of Li_{3.25}Al_{0.25}SiO₄, Li₃PO₄, LiPₓSi_{y}O_{z} (where x, y, and z may each be any positive number), or a combination thereof. The solid electrolyte may be, for example, Li_{3.5}P_{0.5}Si_{0.5}O₄. FIG. 12 is a schematic cross-sectional schematic view of an MLC battery according to an embodiment. Referring to FIG. 12, cathode active material layers 112 may be disposed on both surfaces of a cathode current collector 111 to form a cathode 110. Likewise, anode active material layers 122 may be disposed on both surfaces of an anode current collector 121 to form an anode 120. A solid electrolyte 130 may be disposed between the cathode 110 and the anode 120. External electrodes 140 may be formed at both ends of a battery body 150. The external electrodes 140 may be connected to the cathode 110 and the anode 120, wherein ends of the cathode 110 and the anode 120 are exposed to the outside of the battery body 150. In this regard, the external electrodes 140 may serve as external terminals for electrically connection with the cathode 110 and with the anode 120. One of a pair of the external electrodes 140 may be connected to the cathode 110 of which the end is exposed to the outside of the battery body 150, and the other one of the pair may be connected to the anode 120 of which the other end exposed to the outside of the battery body 150. An MLC battery 150 may be manufactured by sequentially stacking an oxide electrode and a solid electrolyte and then simultaneously performing heat treatment thereon.

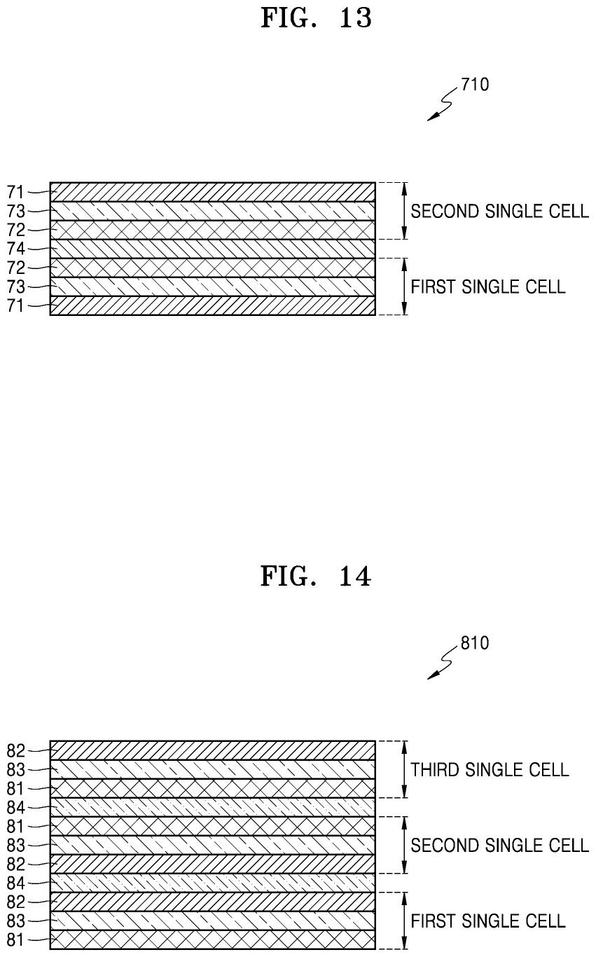

FIGS. 13 and 14 are each a schematic view showing a cross sectional structure of an MLC battery according to another embodiment. As shown in FIG. 13, in an MLC battery 710, a first single cell and a second single cell that are stacked through an inner current collector layer 74. Each of the first single cell and the second single cell comprises a cathode layer 71, a solid electrolyte layer 73, and an anode layer 72 in the stated order. The first single cell, the second single cell, and the internal current collector layer 74 may be stacked in a way that the anode layer 72 of the second single cell is adjacent to a first side of the inner current collector layer 74 (i.e., upper surface in FIG. 13), and that the anode layer 72 of the first single cell is adjacent to a second side of the inner current collector layer 74 (i.e., lower surface in FIG. 13). In FIG. 13, the inner current collector layer 74 is disposed so as to be in contact with the anode layer 72 of each of the first single cell and the second single cell, unit cells 1 and 2, but may be disposed so as to be in contact with the cathode layer 71 of each of the first single cell and the second single cell. The inner current collector layer 74 may include an electronically conductive material. The inner current collector layer 74 may further include an ionic conductive material. When the ionic conductive material is further included, voltage stabilization characteristics may be improved. Since the same poles are disposed on both sides of the inner current collector layer 74 in the MLC battery 710, a monopolar MLC battery 710 in which multiple single cells are connected in parallel through the inner current collector layer 74 may be obtained. Accordingly, a high-capacity MLC battery 710 may be obtained. In the MLC battery 710, the inner current collector layer 74 disposed between the first single cell and the second single cell includes an electrically conductive material, and thus two adjacent single cells may be electrically connected in parallel and at the same time, the inner current collector 74 may be connected to the cathode layer 71 or the anode layer 72 of the two adjacent single cells in an electrically conductive manner. Accordingly, the potential of the cathode layer 71 or the anode layer 72 adjacent to the internal current collector layer 74 may be averaged through the inner current collector layer 74, so that a stable output voltage may be obtained. In addition, the single cells of the MLC battery 710 and in which an external current collecting member, such as a tab, is removed, may be electrically connected in parallel. Accordingly, the MLC battery 710 having excellent space utilization and economic efficiency may be obtained. Referring to FIG. 14, a stacked body includes a cathode layer 81, an anode layer 82, a solid electrolyte layer 83, and an inner current collector layer 84. Such a stacked body may be stacked and thermally compressed to obtain a stacked MLC battery 810. The cathode layer 81 may be composed of one cathode layer sheet. The anode layer 82 may be composed of two anode layer sheets.

### Electrolyte Preparation Method

A method of preparing an electrolyte according to another embodiment includes: providing (e.g., preparing) a first starting material comprising a crystalline Li₅AlO₄ and a lithium compound comprising a crystalline Li₂SO₄; and mechanochemically contacting the first starting material and the lithium compound to prepare an amorphous compound represented by Formula 1:

Li_{w}AlₓS_{y}O₄ Formula 1

wherein, in Formula 1, 2.9≤w≤4.7, 0.3≤x≤0.9, and 0.1≤y≤0.7,
to prepare the electrolyte comprising the compound.

The first starting material may include, for example, powders of the crystalline Li₅AlO₄. The lithium compound may include, for example, powders of the crystalline Li₂SO₄.

By using the crystalline Li₅AlO₄ and the crystalline Li₂SO₄, the electrolyte comprising the amorphous compound, the compound represented by Formula 1 may be formed.

The first starting material and the lithium compound may be, for example, mixed at a molar ratio in a range of about 9:1 to about 3:7, about 8:2 to about 3:7, about 7:3 to about 3:7, or about 6:4 to about 3:7. When the first starting material and the lithium compound are mixed at a molar ratio within the ranges above, the ionic conductivity of the electrolyte may be further improved.

The mechanochemically contacting may comprise, for example, mechanical milling to initiate a mechanochemical reaction. The mechanical milling is not limited to ball milling, jet milling, or a combination thereof, and is not limited thereto. Any suitable method capable of initiating the mechanochemical reaction in the art may be used. The mechanical milling may be, for example, performed dry in an inert atmosphere for about 10 hours to about 1,000 hours, about 10 hours to about 100 hours, or about 10 hours to about 30 hours. An atmosphere may be the atmosphere in which oxygen is substantially excluded. The inert atmosphere may be, for example, the atmosphere containing nitrogen, argon, neon, or a combination thereof. The mechanochemical reaction may be, for example, an exothermic reaction. A reaction for forming the amorphous electrolyte represented by Formula 1 through a reaction between the crystalline Li₅AlO₄ and the crystalline Li₂SO₄ may be an exothermic reaction. the exothermic reaction may occur at a temperature of, for example, in a range of about 100° C. to about 500° C., about 100° C. to about 400° C., about 100° C. to about 300° C., or about 100° C. to about 200° C. The mechanical milling may be, for example, performed dry without using a solvent. When the mechanical milling is performed dry, a post-treatment process such as solvent removal may be omitted.

The preparing of the electrolyte may be performed without additional heating. In the preparing of the electrolyte, a step of applying thermal energy from the outside, such as separate heat treatment, may not be performed. Since the method does not include additional heat treatment, the electrolyte comprising the compound, the compound represented by Formula 1 may be prepared more simply and economically.

The mechanochemical reaction between the first starting material and the lithium compound may include: mechanochemically contacting the first starting material to amorphize the first starting material and prepare a second starting material, and mechanochemically contacting the second starting material and the lithium compound to prepare the electrolyte.

In the preparing of the second starting material by the amorphization of the first starting material, the amorphization may be performed by a mechanochemical reaction. As the mechanochemical reaction, any method capable of performing amorphization may be used. The mechanochemical reaction may be carried out, for example, by mechanical milling. The mechanochemical milling may be performed under the same range of conditions as in the above-described preparing of the electrolyte. The second starting material may include an amorphous Li₅AlO₄. By using the amorphous Li₅AlO₄ and the crystalline Li₂SO₄, the amorphous electrolyte comprising the compound, the compound represented by Formula 1 may be formed more effectively. When the amorphous Li₅AlO₄ is prepared by mechanical milling, the ionic conductivity of the electrolyte comprising the compound, the compound represented by Formula 1 may be further improved.

Hereinafter, the disclosure will be described in detail with reference to Examples and Comparative Examples, but is not limited to the following examples.

### EXAMPLES

### Preparation of Electrolyte

### Example 1

A crystalline Li₅AlO₄ and a crystalline Li₂SO₄ were put into a ball mill reactor at a molar ratio of 9:1, and dry milling was performed in an inert atmosphere for 18 hours to prepare an amorphous electrolyte, Li_{4.7}Al_{0.9}S_{0.1}O₄.

During the milling process, the temperature inside the ball mill reactor was greater than or equal to 100° C.

### Example 2

An amorphous electrolyte, Li_{4.1}Al_{0.7}S_{0.3}O₄, was prepared in the same manner as in Example 1, except that the molar ratio of the crystalline Li₅AlO₄ to the crystalline Li₂SO₄ was changed to 7:3.

### Example 3

An amorphous electrolyte, Li_{3.5}Al_{0.5}S_{0.5}O₄, was prepared in the same manner as in Example 1, except that the molar ratio of the crystalline Li₅AlO₄ to the crystalline Li₂SO₄ was changed to 5:5.

### Example 4

An amorphous electrolyte, Li_{2.9}Al_{0.3}S_{0.7}O₄, was prepared in the same manner as in Example 1, except that the molar ratio of the crystalline Li₅AlO₄ and the crystalline Li₂SO₄ was changed to 3:7.

### Example 5

An amorphous electrolyte, Li_{3.8}Al_{0.6}S_{0.4}O₄, was prepared in the same manner as in Example 1, except that the molar ratio of the crystalline Li₅AlO₄ and the crystalline Li₂SO₄ was changed to 6:4.

### COMPARATIVE EXAMPLE

The crystalline Li₅AlO₄ was used as it was.

### Comparative Example 2

Crystalline Li₅AlO₄ was put into a ball mill reactor, and dry milling was performed in an inert atmosphere for 18 hours to prepare amorphous Li₅AlO₄.

### Comparative Example 3

Crystalline Li₂SO₄ was used as it was.

### Comparative Example 4

An amorphous electrolyte, Li_{2.3}Al_{0.1}S_{0.9}O₄, was prepared in the same manner as in Example 1, except that the molar ratio of the crystalline Li₅AlO₄ and the crystalline Li₂SO₄ was changed to 1:9.

### Comparative Example 5

An amorphous electrolyte, Li_{2.6}Al_{0.2}S_{0.8}O₄, was prepared in the same manner as in Example 1, except that the molar ratio of the crystalline Li₅AlO₄ and the crystalline Li₂SO₄ was changed to 2:8.

The compositions of the electrolytes prepared in Examples 1 to 4 and Comparative Examples 1 to 4 are shown in Table 1.

TABLE 1

| Example | Composition |
|---|---|
| Example 1 | Amorphous Li_{4.7}Al_{0.9}S_{0.1}O₄ |
| Example 2 | Amorphous Li_{4.1}Al_{0.7}S_{0.3}O₄ |
| Example 3 | Amorphous Li_{3.5}Al_{0.5}S_{0.5}O₄ |
| Example 4 | Amorphous Li_{2.9}Al_{0.3}S_{0.7}O₄ |
| Example 5 | Amorphous Li_{3.8}Al_{0.6}S_{0.4}O₄ |
| Comparative Example 1 | Crystalline Li₅AlO₄ |
| Comparative Example 2 | Amorphous Li₅AlO₄ |
| Comparative Example 3 | Crystalline Li₂SO₄ |
| Comparative Example 4 | Amorphous Li_{2.3}Al_{0.1}S_{0.9}O₄ |
| Comparative Example 5 | Amorphous Li_{2.6}Al_{0.2}S_{0.8}O₄ |

### Evaluation Example 1: X-Ray Diffraction (XRD) Analysis

XRD spectra were measured for the electrolytes prepared in Examples 1 to 4 and Comparative Examples 1 to 5, and some of the results are shown in FIG. 1. The XRD spectra were measured by X'pert pro (PANalytical) using Cu Kα radiation (1.54056 Å).

FIG. 1 shows XRD spectra of the crystalline Li₅AlO₄ of Comparative Example 1, the amorphous Li₅AlO₄ of Comparative Example 2, and the amorphous Li_{3.5}Al_{0.5}S_{0.5}O₄ of Example 3.

As shown in FIG. 1, the peak characteristics of the crystalline Li₅AlO₄ of Comparative Example 1 were clearly appeared with a first peak at a diffraction angle of 21.5±1.0° 2θ, a second peak at a diffraction angle of 24.0±1.0° 2θ, and a third peak at a diffraction angle of 35.0±1.0° 2θ.

As shown in FIG. 1, most of the peak characteristics of the crystalline Li₅AlO₄ disappeared, and thus it was confirmed that the amorphous Li₅AlO₄ of Comparative Example 2 was amorphous.

As shown in FIG. 1, most of the peak characteristics of the crystalline Li₅AlO₄ disappeared, and thus it was confirmed that the amorphous Li_{3.5}Al_{0.5}S_{0.5}O₄ of Example 3 was also amorphous.

Although not shown in FIG. 1, it was confirmed that the electrolytes of Examples 1, 2, and 4 were also amorphous.

Referring to FIG. 1, a ratio (Ib/Ia) of an intensity of the second peak at the diffraction angle of 24.0±1.0° 2θ (Ib) to an intensity of the first peak at the diffraction angle of 21.5±1.0° 2θ (Ia) in the XRD spectrum of the Li_{3.5}Al_{0.5}S_{0.5}O₄ was less than or equal to 1.5.

Referring to FIG. 1, a ratio (Ic/Ia) of an intensity of the third peak at the diffraction angle of 35.0±1.0° 2θ (Ic) to an intensity of the first peak at the diffraction angle of 21.5±1.0° 2θ (Ia) in the XRD spectrum of the Li_{3.5}Al_{0.5}S_{0.5}O₄ electrolyte was less than or equal to 1.5.

Referring to FIG. 1, a ratio of (Ia/Iaa) of the intensity of the first peak of the Li_{3.5}Al_{0.5}S_{0.5}O₄ at the diffraction angle 21.5±1.0° 2θ (Ia) in the XRD spectrum of the Li_{3.5}Al_{0.5}S_{0.5}O₄ to an intensity of a first peak of the crystalline Li₅AlO₄ at a diffraction angle of 21.5±1.0° 2θ (Iaa) in the XRD spectrum of the crystalline Li₅AlO₄ measured under the same condition as the Li_{3.5}Al_{0.5}S_{0.5}O₄ was less than or equal to 0.1.

Referring to FIG. 1, a ratio of (Ib/Ibb) of the intensity of the second peak of the Li_{3.5}Al_{0.5}S_{0.5}O₄ at the diffraction angle of 24.0±1.0° 2θ (Ib) in the XRD spectrum of the Li_{3.5}Al_{0.5}S_{0.5}O₄ to an intensity of a second peak of the crystalline Li₅AlO₄ at a diffraction angle of 24.0±1.0° 2θ (Ibb) in the XRD spectrum of the crystalline Li₅AlO₄ measured under the same condition as the Li_{3.5}Al_{0.5}S_{0.5}O₄ was less than or equal to 0.1.

Referring to FIG. 1, a ratio of (Ic/Icc) of an intensity of the third peak of the Li_{3.5}Al_{0.5}S_{0.5}O₄ at a diffraction angle of 35.0±1.0° 2θ (Ic) in the XRD spectrum of the Li_{3.5}Al_{0.5}S_{0.5}O₄ to an intensity of a third peak of the crystalline Li₅AlO₄ at a diffraction angle of 35.0±1.0° 2θ (Icc) in the XRD spectrum of the crystalline Li₅AlO₄ measured under the same condition as the Li_{3.5}Al_{0.5}S_{0.5}O₄ was less than or equal to 0.1.

### Evaluation Example 2: Calculation of Interatomic Distance

In the amorphous Li_{3.8}Al_{0.6}S_{0.4}O₄ and the amorphous Li₅AlO₄, a distance distribution between a lithium atom and an oxygen atom and a distance distribution between lithium atoms, were determined.

The voltage calculation was performed by using quantum calculation. The quantum calculation may be performed according to Density Functional Theory (DFT).

The results of the distance distribution between the lithium atom and the oxygen atom and the distance distribution between the lithium atoms in the amorphous Li_{3.8}Al_{0.6}S_{0.4}O₄ and the amorphous Li₅AlO₄ are shown in FIGS. 2 and 3, respectively.

As shown in FIG. 2, the distance between the lithium atom and the oxygen atom in the amorphous Li_{3.8}Al_{0.6}S_{0.4}O₄ was increased overall, compared to the distance between the lithium atom and the oxygen atom in the amorphous Li₅AlO₄. Accordingly, it was confirmed that lithium mobility was increased due to a SO₄²⁻ unit in the amorphous Li_{3.8}Al_{0.6}S_{0.4}O₄ compared to the amorphous Li₅AlO₄. For example, as shown in FIG. 2, a first distance, which is the distance between the lithium atom and the oxygen atom in the amorphous Li_{3.8}Al_{0.6}S_{0.4}O₄, was greater than a second distance, which is the distance between the lithium atom and the oxygen atom in the amorphous Li₅AlO₄. The first distance refers to a distance at a highest frequency between the lithium atom and the oxygen atom in the distance distribution curve of the lithium atom and the oxygen atom in the amorphous Li_{3.8}Al_{0.6}S_{0.4}O₄, and the second distance refers to a distance at a highest frequency between the lithium atom and the oxygen atom in the distance distribution curve of the lithium atom and the oxygen atom in the amorphous Li₅AlO₄. Referring to FIG. 2, the first distance was greater than 2 Å, and the second distance was less than 2 Å.

As shown in FIG. 3, a proportion in which the distance between lithium atoms in the amorphous Li_{3.8}Al_{0.6}S_{0.4}O₄ has a value near 3 Å was increased compared to a proportion in which the distance between lithium atoms in the amorphous Li₅AlO₄ has a value near 3 Å. Accordingly, it was confirmed that lithium diffusion site was increased due to a SO₄²⁻ unit in the amorphous Li_{3.8}Al_{0.6}S_{0.4}O₄ compared to the amorphous Li₅AlO₄. For example, as shown in FIG. 3, a proportion of lithium atoms having a third distance, which is the distance between the lithium atoms in the amorphous Li_{3.8}Al_{0.6}S_{0.4}O₄, was greater than a proportion of lithium atoms having a fourth distance, which is the distance between the lithium atoms in the amorphous Li₅AlO₄. The proportion of lithium atoms having the third distance refers to a proportion in which the distance between the lithium atoms in the distance distribution curve of the lithium atoms of the amorphous Li_{3.8}Al_{0.6}S_{0.4}O₄ is within a range of about 2.5 Å to about 3.5 Å, and the proportion of lithium atoms having the fourth distance refers to a proportion in which the distance between the lithium atoms in the distance distribution curve of the lithium atoms of the amorphous Li₅AlO₄ is within a range of about 2.5 Å to about 3.5 Å.

### Evaluation Example 3: Measurement of Ionic Conductivity and Lithium Diffusion Barrier

The electrolyte powders prepared in Examples 1 to 4 and Comparative Examples 1 to 5 were pulverized, and then pressed by using a uniaxial pressure to prepare pellets. By sputtering gold (Au) electrodes on both sides of the prepared pellets, shielding electrodes were deposited. For a sample including the shielding electrode formed on the both sides, impedance thereof was measured according to a 2-probe method using an impedance analyzer (Solartron 1400A/1455A impedance analyzer). Here, the frequency range was about 0.1 Hertz (Hz) to about 1 megaHertz (MHz), and the amplitude voltage was 10 millivolts (mV). The measurement was performed at 25° C. in the air atmosphere. The resistance values were obtained from the arc of the Nyquist plot for the impedance measurement results, and the ionic conductivity was calculated by correcting the electrode area and the pellet thickness from the resistance values, and the results are shown in Table 2.

In addition, by changing a temperature of a chamber accommodating the pellets during the measurement, the temperature-dependent ionic conductivity was measured. From the slope obtained by converting to Arrhenius plots showing the changes in the temperature-dependent ionic conductivity, the lithium diffusion barrier corresponding to the activation energy (Ea) according to the Arrhenius equation represented by Equation 1 was calculated. The results are shown in FIG. 4 and Table 2.

σ=A exp(−Ea/kT) Equation 1

wherein, in Equation 1, σ denotes conductivity, A denotes a frequency factor, Ea denotes activation energy, k denotes a Boltzmann constant, and T denotes an absolute temperature.

TABLE 2

| | Lithium diffusion | |
|---|---|---|
| | barrier | Ionic conductivity |
| | [meV] | [S/cm] |
| Example 1 | 527 | 1.5 × 10⁻⁷ |
| Example 2 | 505 | 1.6 × 10⁻⁷ |
| Example 3 | 551 | 2.6 × 10⁻⁷ |
| Example 4 | 565 | 3.0 × 10⁻⁷ |
| Example 5 | 555 | 2.4 × 10⁻⁷ |
| Comparative | 725 | 0.01 × 10⁻⁷ |
| Example 1 | | |
| Comparative | 629 | 1.1 × 10⁻⁷ |
| Example 2 | | |
| Comparative | — | 0.01 × 10⁻⁷ |
| Example 3 | | |
| Comparative | 621 | 0.2 × 10⁻⁷ |
| Example 4 | | |
| Comparative | 597 | 1.1 × 10⁻⁷ |
| Example 5 | | |

As shown in FIG. 4 and Table 2, the electrolytes of Examples 1 to 5 exhibited improved ionic conductivity and reduced lithium diffusion barrier compared to the electrolytes of Comparative Examples 1 to 5.

In detail, the amorphous electrolytes of Examples 1 to 5 exhibited improved ionic conductivity compared to the crystalline Li₅AlO₄ of Comparative Example 1, the amorphous Li₅AlO₄ of Comparative Example 2, and the crystalline Li₂SO₄ of Comparative Example 3.

According to an embodiment, a novel electrolyte having improved ionic conductivity may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An electrolyte comprising a compound, the compound represented by Formula 1:
Li_{w}AlₓS_{y}O₄ Formula 1
wherein, in Formula 1, 2.9≤w≤4.7, 0.3≤x≤0.9, and 0.1≤y≤0.7, and
wherein the compound is amorphous.

2. The electrolyte of claim 1,
wherein the electrolyte has a first peak at a diffraction angle of 21.5±1.0° 2θ and a second peak at a diffraction angle of 24.0±1.0° 2θ, when analyzed by an X-ray diffraction using CuKα radiation, and
wherein a ratio of an intensity of the second peak to an intensity of the first peak is less than or equal to about 1.5.

3. The electrolyte of claim 1,
wherein the electrolyte has a first peak at a diffraction angle of 21.5±1.0° 2θ and a third peak at a diffraction angle of 35.0±1.0° 2θ, when analyzed by an X-ray diffraction using CuKα radiation, and
wherein a ratio of an intensity of the third peak to an intensity of the first peak is less than or equal to about 1.5.

4. The electrolyte of claim 1, wherein a ratio of an intensity of a first peak of the electrolyte at a diffraction angle of 21.5±1.0° 2θ in an X-ray diffraction spectrum of the electrolyte to an intensity of a first peak of a crystalline Li₅AlO₄ at a diffraction angle of 21.5±1.0° 2θ in an X-ray diffraction spectrum of the crystalline Li₅AlO₄ measured under a same condition as the electrolyte and using CuKα radiation, is less than or equal to about 0.1,
a ratio of an intensity of a second peak of the electrolyte at a diffraction angle of 24.0±1.0° 2θ in an X-ray diffraction spectrum of the electrolyte to an intensity of a second peak of the crystalline Li₅AlO₄ at a diffraction angle of 24.0±1.0° 2θ in an X-ray diffraction spectrum of the crystalline Li₅AlO₄ measured under the same condition as the electrolyte and using CuKα radiation is less than or equal to about 0.1, or
a ratio of an intensity of a third peak of the electrolyte at a diffraction angle of 35.0±1.0° 2θ in an X-ray diffraction spectrum of the electrolyte to an intensity of a second third peak of the crystalline Li₅AlO₄ at a diffraction angle of 35.0±1.0° 2θ in an X-ray diffraction spectrum of the crystalline Li₅AlO₄ measured under the same condition and using CuKα radiation as the electrolyte is less than or equal to about 0.1.

5. The electrolyte of claim 1, wherein a first distance between a lithium atom and an oxygen atom in the compound represented by Formula 1 is greater than a second distance between a lithium atom and an oxygen atom in an amorphous Li₅AlO₄,
the first distance is a distance at a highest frequency between the lithium atom and the oxygen atom in a distance distribution curve of the lithium atoms and the oxygen atoms in the compound represented by Formula 1, and
the second distance is a distance at a highest frequency between the lithium atoms and the oxygen atoms in a distance distribution curve of the lithium atoms and the oxygen atoms in the amorphous Li₅AlO₄.

6. The electrolyte of claim 5, wherein the first distance is greater than about 2 angstroms, and the second distance is less than about 2 angstroms.

7. The electrolyte of claim 1,
wherein a proportion of lithium atoms having a third distance in the compound is greater than a proportion of lithium atoms having a fourth distance in the amorphous Li₅AlO₄,
wherein the proportion of lithium atoms having the third distance is the proportion in which the distance between the lithium atoms in a distance distribution curve of the lithium atoms in the compound represented by Formula 1 within a range of about 2.5 angstroms to about 3.5 angstroms, and
wherein the proportion of lithium atoms having the fourth distance is the proportion in which the distance between the lithium atoms in a distance distribution curve of the lithium atoms in the amorphous Li₅AlO₄ is within a range of about 2.5 angstroms to about 3.5 angstroms.

8. The electrolyte of claim 1, wherein the compound comprises an ionic conductor, and the ionic conductor comprises a AlO₄⁵⁻ unit and a SO₄²⁻ unit.

9. The electrolyte of claim 8, wherein, a proportion of the AlO₄⁵⁻ unit is about 30 percent to about 90 percent and a proportion of the SO₄²⁻ unit is about 10 percent to about 70 percent, based on a total content of the AlO₄⁵⁻ unit and the SO₄²⁻ unit in the electrolyte.

10. The electrolyte of claim 8, wherein a lithium atom is randomly disposed within the ionic conductor.

11. The electrolyte of claim 1, wherein an ionic conductivity of the electrolyte at about 25° C. is greater than or equal to about 1×10⁻⁷ Siemens per centimeter, and
a lithium diffusion barrier in the electrolyte is less than or equal to about 600 millielectronvolts.

12. A lithium battery comprising:
a cathode;
an anode; and
an electrolyte disposed between the cathode and the anode,
wherein the cathode, the anode, the electrolyte, or a combination thereof, comprises the electrolyte according to claim 1.

13. The lithium battery of claim 12, wherein the lithium battery is a lithium ion battery, an all-solid-state battery, or a multilayer ceramic battery.

14. A method of preparing an electrolyte comprising a compound, the method comprising:
providing a first starting material comprising a crystalline Li₅AlO₄ and a lithium compound comprising a crystalline Li₂SO₄; and
mechanochemically contacting the first starting material and the lithium compound to prepare an amorphous compound represented by Formula 1
Li_{w}AlₓS_{y}O₄ Formula 1
wherein, in Formula 1, 2.9≤w≤4.7, 0.3≤x≤0.9, and 0.1≤y≤0.7,
to prepare the electrolyte comprising the compound.

15. The method of claim 14, wherein the first starting material and the lithium compound are mixed at a molar ratio of about 9:1 to about 3:7.

16. The method of claim 14, wherein the mechanochemically contacting comprises mechanical milling to initiate a mechanochemical reaction, and the mechanical milling is performed dry in an inert atmosphere for about 10 hours to about 1,000 hours, and
the mechanochemical reaction is an exothermic reaction, and a temperature of the exothermic reaction is about 100° C. to about 500° C.

17. The method of claim 14, wherein the preparing of the electrolyte is performed without additional heating.

18. The method of claim 14, wherein the mechanochemically contacting the first starting material and the lithium compound comprises
mechanochemically contacting the first starting material to amorphize the first starting material and prepare a second starting material; and
mechanochemically contacting the second starting material and the lithium compound to prepare the electrolyte.

19. The method of claim 18, wherein the mechanochemically contacting the first starting material comprises milling to amorphize by a mechanochemical reaction, and the second starting material comprises an amorphous Li₅AlO₄.
